(19) United States
(12) Patent Application Publication
(10) Pub. No.: US 2025/0216086 A1
(43) Pub. Date: Jul. 3, 2025

(54) COOKING APPARATUS

(71) Applicant: SAMSUNG ELECTRONICS CO., LTD., Suwon-si (KR)

(72) Inventors: Sooncheol KWEON, Suwon-si (KR); Sangbeom KIM, Suwon-si (KR); Sangbum KIM, Suwon-si (KR); Bokhyun JANG, Suwon-si (KR)

(73) Assignee: SAMSUNG ELECTRONICS CO., LTD., Suwon-si (KR)

(21) Appl. No.: 18/924,552

(22) Filed: Oct. 23, 2024

Related U.S. Application Data
(63) Continuation of application No. PCT/KR2024/014948, filed on Oct. 2, 2024.

(30) Foreign Application Priority Data
Dec. 29, 2023 (KR) 10-2023-0197766

(51) Int. Cl. F24C 15/02; E05B 47/00; E05B 65/00

(52) U.S. Cl. CPC F24C 15/022; E05B 47/0012; E05B 65/00; E05B 2047/0017; E05B 2047/0024; E05B 2047/0067

(57) ABSTRACT

A cooking apparatus may include: a door to open and close a chamber and including a locking portion, a latch movable between a first latch position in which the latch is engaged with the locking portion and a second latch position in which the latch is disengaged from the locking portion, a slider movable between a first and second slider position corresponding to the first and second latch position, and a pusher movable to a first pusher position of releasing the pressing of the slider or a second pusher position of pressing the slider. The pusher may move the slider from the first slider position to the second slider position with the pusher moved from the first pusher position to the second pusher position. The slider may be movable between the first slider position and the second slider position with the pusher located at the first pusher position.

### CROSS-REFERENCE TO RELATED APPLICATIONS

This is a continuation application, under 35 U.S.C. § 111 (a), of International Application No. PCT/KR2024/014948, filed Oct. 2, 2024, which claims priority under 35 U.S.C. § 119 to Korean Patent Application No. 10-2023-0197766, filed Dec. 29, 2023, in the Korean Intellectual Property Office, the disclosures of which are incorporated herein in their entireties by reference.

### TECHNICAL FIELD

The present disclosure relates to a cooking apparatus.

### BACKGROUND ART

Cooking apparatuses are apparatuses for cooking by heating a cooking object such as food, and refer to apparatuses capable of providing various functions related to cooking, such as heating, thawing, drying, and sterilization of a cooking object. Cooking apparatuses include, for example, an oven such as a gas oven and an electric oven, a microwave heating device (hereinafter referred to as a microwave oven), a gas range, an electric range, a hood combined microwave oven (Over the Range; OTR), a gas grill or an electric grill, and the like.

Ovens are apparatuses that cook food by directly transferring heat to the food through a heating source such as a heater or by heating the inside of a cooking chamber. Microwave ovens are apparatuses that cook food by frictional heat generated between molecules by disturbing a molecular arrangement of the food using high frequency as a heating source.

A cooking apparatus includes a cooking chamber for cooking food and a door for opening and closing the cooking chamber. The cooking apparatus needs to be operated in a state in which the cooking chamber is closed, and therefore includes a latch device provided to secure the door in a closed state. A latch of the latch device may rotate in a main body to support the door or release the door.

### DISCLOSURE

### Technical Problem

The present disclosure is directed to providing a cooking apparatus having an improved structure such that a door may be opened automatically.

The present disclosure is directed to providing a cooking apparatus having an improved structure such that a latch may efficiently move to a position thereof in a process in which a door is opened or closed.

The present disclosure is directed to providing a cooking apparatus having an improved structure to allow a door to be manually opened even when a driving module of a latch device does not operate.

Technical tasks to be achieved in this document are not limited to the technical tasks mentioned above, and other technical tasks not mentioned will be clearly understood by those skilled in the art to which the present invention belongs from the description below.

### Technical Solution

A cooking apparatus according to an embodiment of the present disclosure may include a main body including a cooking chamber; a door to open and close the cooking chamber and including a door locking portion; a latch mounted on the main body and that is movable, with the cooking chamber closed, between a first latch position in which the latch is engaged with the door locking portion and a second latch position in which the latch is disengaged from the door locking portion; a slider connected to the latch and that is movable between a first slider position corresponding to the first latch position and a second slider position corresponding to the second latch position; and a pusher configured to press the slider and that is movable to a first pusher position of releasing the pressing of the slider and movable to a second pusher position of pressing the slider. The pusher may be configured to move the slider from the first slider position to the second slider position with the pusher moved from the first pusher position to the second pusher position, so as to move the latch from the first latch position to the second latch position. The slider may be configured to be movable between the first slider position and the second slider position with the pusher located at the first pusher position, so as to correspondingly move the latch between the first latch position and the second latch position.

With the slider moved to the first slider position, the slider may be adjacent to the pusher. With the slider moved to the second slider position and the pusher located at the first pusher position, the slider may be spaced apart from the pusher.

The pusher may be rotatable with respect to the main body about a rotation axis of the pusher from the first pusher position to the second pusher position, and from the second pusher position to the first pusher position.

The pusher may be configured to rotate about the rotation axis of the pusher in a direction from the first pusher position toward the second pusher position, and from the second pusher position toward the first pusher position.

The pusher may include a plurality of contact portions extending in a radial direction from the rotation axis of the pusher and that are arranged along a rotational direction of the pusher. The plurality of contact portions may be configured so that, as the pusher is moved from the first pusher position to the second pusher position, at least one contact portion of the plurality of contact portions may contact the slider and may press the slider from the first slider position toward the second slider position.

The slider may be configured so that, with the slider moved to the first slider position, one end of the slider may be adjacent to the pusher and may be located between a pair of adjacent contact portions of the plurality of contact portions.

One of the pair of adjacent contact portions may be configured to press the one end of the slider as the pusher is rotated from the first pusher position to the second pusher position.

The latch may be configured to move from the second latch position to the first latch position as the pusher is moved from the second pusher position to the first pusher position.

The cooking apparatus may further include an elastic spring connected to the latch and elastically biased to apply an elastic force to the latch in a direction in which the latch moves from the second latch position to the first latch position.

The latch may be configured to be rotatable about a rotation axis thereof between the first latch position and the second latch position. As the slider is moved from the first slider position to the second slider position, the slider may be moved toward the rotation axis of the latch. As the slider is moved from the second slider position to the first slider position, the slider may move away from the rotation axis of the latch.

The slider may be configured to be linearly movable between the first slider position and the second slider position.

The cooking apparatus may further include a slider guide that may be fixed to the main body and may be configured to guide the slider so that the slider moves linearly between the first slider position and the second slider position.

The cooking apparatus may further include a pusher position detection sensor that may be configured to detect a position of the pusher.

The pusher position detection sensor may include a switch configured to generate an electrical signal depending on whether or not the switch is pressed by the pusher. With the pusher moved to the first pusher position, the pusher may be spaced apart from the switch. As the pusher is moved from the first pusher position to the second pusher position, the switch may be pressed by the pusher.

The cooking apparatus may further include a connecting rod connecting the latch and the slider.

A cooking apparatus according to an embodiment of the present disclosure may include a main body forming a cooking chamber, a door provided to open and close the cooking chamber, a latch disposed in the main body and provided to be rotatable between a first latch position of supporting the door to prevent opening of the door and a second latch position of releasing the door to allow the door to be opened, when the door closes the cooking chamber, a slider disposed in the main body and connected to the latch to be movable in conjunction with a position of the latch when the latch rotates between the first latch position and the second latch position, and a pusher disposed in the main body and provided to be rotatable to a first pusher position of releasing pressing of the slider or a second pusher position of pressing the slider. The slider may be provided to rotate the latch from the first latch position to the second latch position when the pusher moves from the first pusher position to the second pusher position. The slider may be provided to move in a direction of becoming away from the pusher as the latch rotates from the first latch position to the second latch position when the pusher is located at the first pusher position.

A cooking apparatus according to an embodiment of the present disclosure may include a main body forming a cooking chamber, a door provided to be rotatable with respect the main body to open and close the cooking chamber and including a door locking portion, a latch disposed in the main body and provided to be movable between a first latch position in which the latch is engaged with the door locking portion and a second latch position in which the latch is disengaged from the door locking portion, when the cooking chamber is closed, a driving source disposed in the main body and provided to generate a driving force, and a pusher disposed in the main body and provided to be movable between a first pusher position and a second pusher position by receiving the driving force from the driving source. The pusher may be provided to move the latch from the first latch position to the second latch position when moving from the first pusher position to the second pusher position. The latch may be provided to be movable between the first latch position and the second latch position when the pusher is located at the first pusher position.

### DESCRIPTION OF DRAWINGS

FIG. 1 is a perspective view of a cooking apparatus according to an embodiment of the present disclosure.

FIG. 2 is a front view illustrating a state in which a door is opened in the cooking apparatus according to an embodiment of the present disclosure.

FIG. 3 is a view illustrating a latch device in the cooking apparatus according to an embodiment of the present disclosure.

FIG. 4 is a view illustrating a latch mounted on a main body and a portion of the door in the cooking apparatus according to an embodiment of the present disclosure.

FIG. 5 is a top view illustrating a portion of the main body and the latch mounted therein in the cooking apparatus according to an embodiment of the present disclosure.

FIG. 6 is a view illustrating a driving module and a locking module of the latch device in the cooking apparatus according to an embodiment of the present disclosure.

FIG. 7 is an exploded view of the driving module and the locking module of the latch device in the cooking apparatus according to an embodiment of the present disclosure.

FIG. 8 is a top view illustrating components of the driving module, such as a slider, a connecting rod, and a pusher of the latch device, in the cooking apparatus according to an embodiment of the present disclosure.

FIG. 9 is a view illustrating a state of the latch device when the door is closed in the cooking apparatus according to an embodiment of the present disclosure.

FIG. 10 is a view illustrating that the latch device is operating to open the door in the cooking apparatus according to an embodiment of the present disclosure.

FIG. 11 is a view illustrating that the latch device is operating such that the latch is returned to an original position thereof after being disengaged from a door locking portion in the cooking apparatus according to an embodiment of the present disclosure.

FIG. 12 is a view illustrating an operation of the latch device when the door is forcibly opened in a state in which the driving module does not operate in the cooking apparatus according to an embodiment of the present disclosure.

FIG. 13 is a view illustrating that the latch is returning to the original position thereof after being disengaged from the door locking portion in the cooking apparatus according to an embodiment of the present disclosure.

FIG. 14 is a view illustrating an operation of the latch when the door is closed in the cooking apparatus according to an embodiment of the present disclosure.

FIG. 15 is a view illustrating an operation of the latch when the door is closed in the cooking apparatus according to an embodiment of the present disclosure.

### Mode of the Disclosure

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used in the present specification are for the purpose of describing the embodiments and are not intended to restrict and/or to limit the present disclosure. For example, the singular expressions herein may include plural expressions, unless the context clearly dictates otherwise. Also, the terms “includes” and “has” are intended to indicate that there are features, numbers, steps, operations, components, parts, or combinations thereof described in the specification, and do not exclude the presence or addition of one or more other features, numbers, steps, operations, components, parts, or combinations thereof.

It will be understood that, although the terms “first,” “second,” and the like may be used herein to describe various components, these components should not be limited by these terms, these terms are only used to distinguish one component from another. For example, without departing from the scope of the present disclosure, a first component may be referred to as a second component, and similarly, the second component may also be referred to as a first component. The term “and/or” includes any combination of a plurality of related items or any one of a plurality of related items.

In this specification, when a part is referred to as being “connected” to another part, this includes not only a case where they are directly connected, but also a case where they are indirectly connected.

The terms “upward,” “downward,” “forward,” “rearward,” “front surface,” “left side,” and “right side” used in the following description are defined with reference to the drawings, and the shape and position of each component are not limited by these terms. For example, the terms “upward” and “downward” may each be defined with respect to a Z direction illustrated in the drawings. The terms “forward” and “rearward” may each be defined with respect to an X direction illustrated in the drawings. The terms “left side” and “right side” may each be defined with respect to a Y direction illustrated in the drawings.

Hereinafter, embodiments of the present disclosure will be described in detail with reference to the accompanying drawings.

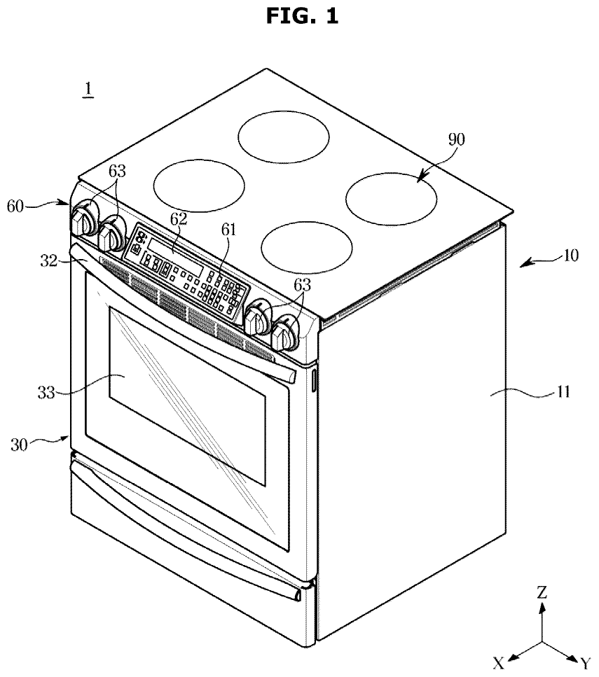

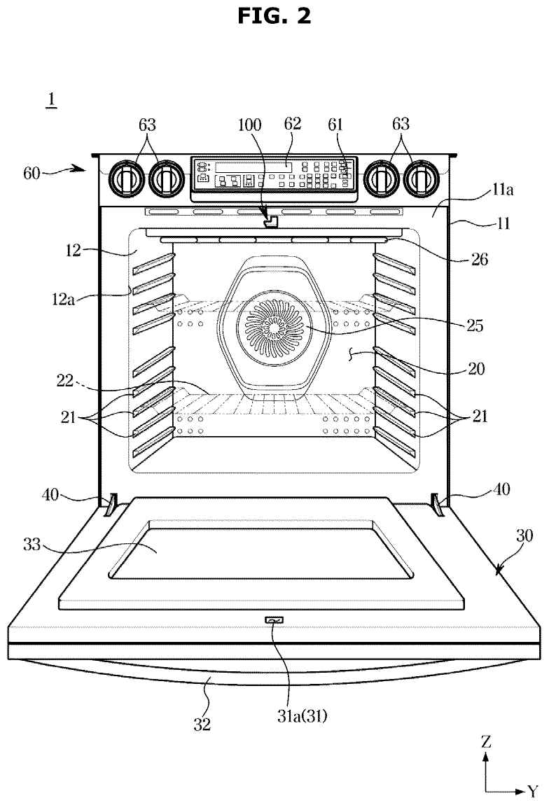

FIG. 1 is a perspective view of a cooking apparatus according to an embodiment of the present disclosure. FIG. 2 is a front view illustrating a state in which a door is opened in the cooking apparatus according to an embodiment of the present disclosure.

Referring to FIGS. 1 and 2, a cooking apparatus 1 according to an embodiment of the present disclosure may include a cooking chamber 20, a main body 10 forming the cooking chamber 20, and a door 30 provided to open and close the cooking chamber 20.

The main body 10 may include an inner case 12 having the cooking chamber 20 formed therein. The inner case 12 may be provided inside an outer case 11 of the main body 10, which will be described later. Specifically, the inner case 12 may be disposed inside the outer case 11 and may be coupled to the outer case 11.

The cooking chamber 20 may be formed with an open front side to allow food to be put in and taken out. The inner case 12 may include a front opening 12a formed to be open for the entry and exit of food into and out of the cooking chamber 20. One surface of the main body 10 on which the front opening 12a is formed is defined as a front surface of the main body 10.

As an example, the inner case 12 may be formed to have a substantially box shape with an open front side.

An inner wall of the inner case 12 may be coated to prevent corrosion caused by condensation that may occur in a condensation process of water vapor or moisture contained in food itself. The inner wall of the inner case 12 may be dried by heat generated in a food cooking process.

Inside the cooking chamber 20, a tray 22 on which food or a cooking vessel containing food may be placed and a rack 21 supporting the tray 22 may be provided. As an example, the tray 22 may be provided to be detachable from the rack 21. As an example, the rack 21 may be provided on a left inner wall or a right inner wall of the inner case 12.

The cooking apparatus 1 may include a heater 26 configured to provide heat to the inside of the cooking chamber 20. As an example, the heater 26 may include a gas burner provided to generate heat by burning gaseous fuel. However, the types of components included in the cooking apparatus 1 in order to heat food inside the cooking chamber 20 are not limited thereto, and the cooking apparatus 1 may include a magnetron (not shown) or the like provided to generate heat by emitting electromagnetic waves into the cooking chamber 20 and thereby causing rotation of water molecules inside food.

The cooking apparatus 1 may include a convection fan 25 provided to circulate air inside the cooking chamber 20. The convection fan 25 may circulate air inside the cooking chamber 20 by receiving a rotational force from a fan motor and rotating. As the air inside the cooking chamber 20 is circulated by the convection fan 25, the heat generated by the heater 26 may be evenly transferred inside the cooking chamber 20. As an example, the convection fan 25 may be disposed on a rear surface of the cooking chamber 20, but a position thereof is not limited thereto.

The cooking apparatus 1 may include the outer case 11. Various components of the cooking apparatus 1 may be accommodated inside the outer case 11. The outer case 11 may form an outer appearance of the cooking apparatus 1. The outer case 11 may be disposed to surround an upper surface, lower surface, rear surface, left surface, right surface, and the like of the inner case 12 from the outside.

Between the inner case 12 and the outer case 11, an insulator (not shown) may be provided to prevent heat inside the cooking chamber 20 from being released to the outside of the main body 10. As an example, the insulator may include a material such as fiberglass, asbestos, etc.

The outer case 11 may include a front frame 11a. The front frame 11a may be provided on a front side of the main body 10. The front frame 11a may form at least a portion of the front surface of the main body 10. When the door 30 closes the cooking chamber 20, the front frame 11a may be covered by the door 30.

The front frame 11a may be formed in the shape of a frame having an opening. The front frame 11a may be formed in the shape of a frame surrounding the front opening 12a.

As an example, the inner case 12 may be coupled to the front frame 11a. A portion of the front side of the inner case 12 may be coupled to the front frame 11a.

In an embodiment, a latch hole 11h, which will be described later, may be formed on the front frame 11a.

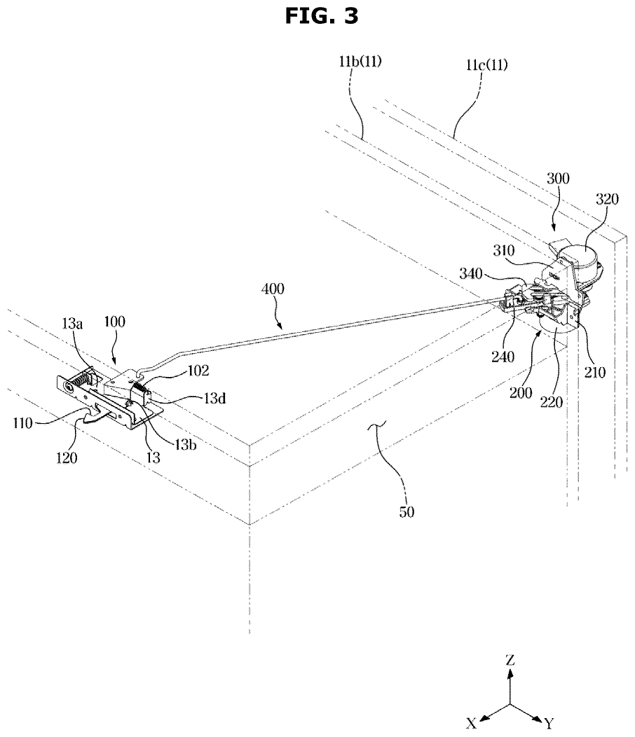

The outer case 11 may include a rear panel 11b (see FIG. 3) disposed on a rear side of the cooking apparatus 1. The rear panel 11b may form at least a portion of a rear outer appearance of the cooking apparatus 1. On the rear panel 11b, various components including electrical components such as a gas supply pipe, a printed circuit board for control, the convection fan 25, which will be described later, a driving module 200, and a locking module 300 may be mounted.

The outer case 11 may include a rear cover 11c (see FIG. 3) covering at least a portion of the rear panel 11b. The rear cover 11c may cover at least a portion of the rear panel 11b from the rear. The rear cover 11c may form at least a portion of the rear outer appearance of the cooking apparatus 1. The rear cover 11c may be coupled to the rear of the rear panel 11b.

The rear cover 11c may cover various components such as the gas supply pipe, the printed circuit board, the convection fan 25, the driving module 200, and the locking module 300, which are mounted on the rear panel 11b, to protect the components against external impact.

In addition, the outer case 11 may include a left panel forming a left surface of the cooking apparatus 1, a right panel forming a right surface of the cooking apparatus 1, a base forming a lower surface of the cooking apparatus 1, and the like.

The cooking apparatus 1 may include an electrical room 50 (see FIG. 3) provided inside the main body 10 to accommodate various electrical components therein. The electrical room 50 may be formed to be partitioned from the cooking chamber 20. The electrical room 50 may be formed inside the outer case 11. The electrical room 50 may be formed outside the inner case 12. For example, the electrical room 50 may accommodate components such as a printed circuit board on which electronic components for controlling operations of various components of the cooking apparatus 1 are mounted, a cooling fan module, and a lever device, which will be described later. As an example, the electrical room 50 may be provided at an upper portion of the main body 10.

The cooking apparatus 1 may include a user interface 60. The user interface 60 may be configured to obtain a user input or output information about the cooking apparatus 1, such as a cooking mode. For example, the user interface 60 may include an input button 61 provided to obtain the user input. For example, the user interface 60 may include a display 62 configured to display operation information of the cooking apparatus 1. For example, the user interface 60 may include a knob 63.

As an example, the user interface 60 may be mounted on the main body 10. Specifically, the user interface 60 may be mounted at the upper portion of the main body 10. The user interface 60 may be mounted on the front side of the main body 10. The position of the user interface 60 is not limited thereto, and the user interface 60 may be provided at various positions in the cooking apparatus 1, such as an upper portion of the door 30.

The cooking apparatus 1 may include a cooktop 90 on which a cooking vessel containing food may be placed to heat the cooking vessel. The cooktop 90 may be mounted on the main body 10. Specifically, the cooktop 90 may be mounted at the upper portion of the main body 10. The cooktop 90 may form an upper surface of the cooking apparatus 1. As an example, as illustrated in FIG. 1, the cooktop 90 may include an induction cooktop having a coil provided therein and configured to heat the cooking vessel with an electromagnetic field induced by flowing a high-frequency current through the coil. Unlike this, as an example, the cooktop 90 may include a gas burner cooktop generating heat by burning gas fuel.

The door 30 of the cooking apparatus 1 may be provided to be rotatable with respect to the main body 10 to open and close the cooking chamber 20. As an example, the door 30 may be rotatably coupled to a lower portion of the main body 10. The door 30 may be provided to be rotatable about a rotation axis positioned at the lower portion of the main body 10. As illustrated in FIGS. 1 and 2, the rotation axis of the door 30 may extend in a horizontal direction Y.

The door 30 may include a handle 32 provided such that a user may grasp the handle 32 to open and close the door 30. To enable the user to easily open and close the door 30, the handle 32 may be disposed adjacent to a portion of the door 10 opposite to the rotation axis of the door 30. Although FIG. 1 illustrates an embodiment in which the handle 32 is provided on a front surface of the door 30, the present disclosure is not limited thereto, and the handle 32 may be provided in various positions of the door 30. Herein, the ‘front surface of door 30’ refers to one surface of the door 30 facing forward in an X direction when the door 30 closes the cooking chamber 20.

The door 30 may include a transparent portion 33 formed transparently so that the user may see the inside of the cooking chamber 20 even when the door 30 closes the cooking chamber 20. The transparent portion 33 may include various transparent materials such as a glass material and the like. As an example, the transparent portion 33 may include a plurality of glass plates disposed to be spaced apart from each other and forming an insulating space therebetween to prevent heat inside the cooking chamber 20 from being transferred to the outside of the door 30 through the transparent portion 33.

The cooking apparatus 1 may include a hinge 40 provided to connect the main body 10 and the door 30. The hinge 40 may rotatably support the door 30. The hinge 40 may be coupled to each of the main body 10 and the door 30. The door 30 may be coupled to the main body 10 by the hinge 40.

As an example, the hinge 40 may be mounted on the lower portion of the main body 10.

As an example, the hinge 40 may be provided as a pair of the hinges 40.

The cooking apparatus 1 described above with reference to FIGS. 1 and 2 is only an example of a cooking apparatus according to the present disclosure, and the present disclosure is not limited thereto and the cooking apparatus may include various configurations.

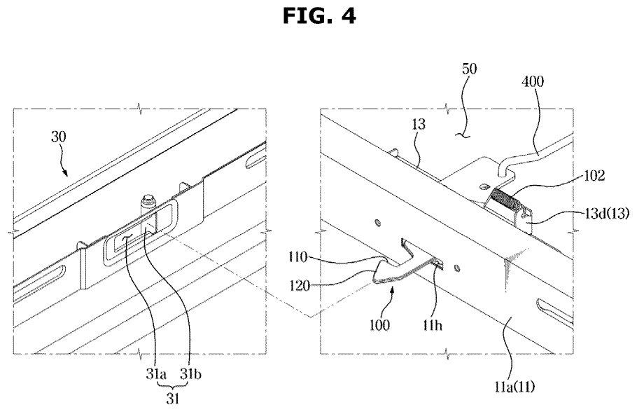

FIG. 3 is a view illustrating a latch device in the cooking apparatus according to an embodiment of the present disclosure. FIG. 4 is a view illustrating a latch mounted on a main body and a portion of the door in the cooking apparatus according to an embodiment of the present disclosure.

Referring to FIGS. 3 and 4, the cooking apparatus 1 according to an embodiment of the present disclosure may include a latch device. The latch device may be provided to secure the door 30 closed or to automatically open the door 30. The latch device may be provided to support the door 30 in a closed position, or to release the door 30 and open the door 30.

Specifically, the latch device of the cooking apparatus 1 may include a latch 100 and the driving module 200 provided to drive the latch 100.

The latch 100 may be disposed in the main body 10. Specifically, the latch 100 may be disposed on the front side of the main body 10. The latch 100 may be disposed adjacent to the position of the door 30 when the door 30 closes the cooking chamber 20. The latch 100 may be disposed at the upper portion of the main body 10.

A portion of the latch 100 may be disposed inside the main body 10. The other portion of the latch 100 may be disposed outside the main body 10. The latch 100 may be installed in the electrical room 50, and a portion of the latch 100 may protrude to the outside of the electrical room 50.

As an example, the latch 100 may penetrate the front side of the main body 10. That is, the latch 100 may penetrate the front frame 11a and a portion thereof may protrude to the outside of the electrical room 50. The front frame 11a may include the latch hole 11h formed to be penetrated by the latch 100. The latch hole 11h may be formed to connect the inside and outside of the main body 10. The latch hole 11h may be formed in a shape of penetrating the front frame 11a in a front-rear direction X. When the door 30 closes the cooking chamber 20, the latch hole 11h may face the door 30. In other words, when the door 30 closes the cooking chamber 20, the latch hole 11h may be covered by the door 30.

As an example, the latch hole 11h may be formed at an upper portion of the front frame 11a.

The latch 100 may be mounted on the main body 10. The latch 100 may be supported by the main body 10. The main body 10 may include a latch bracket 13 provided to support the latch 100. The latch bracket 13 may be fixed to the main body 10.

The latch bracket 13 may be provided on the front side of the main body 10. The latch bracket 13 may be disposed within the electrical room 50. The latch bracket 13 may be disposed adjacent to the front frame 11a. The latch bracket 13 may be disposed adjacent to the latch hole 11h. As an example, the latch bracket 13 may be disposed at the rear of the latch hole 11h and may be disposed at a height substantially corresponding to the latch hole 11h.

As an example, the latch 100 may penetrate through each of the latch bracket 13 and the latch hole 11h.

A detailed structure of the latch bracket 13 will be described later.

The latch 100 may be provided to be movable with respect to the main body 10. The latch 100 may be provided to be movable with respect to the latch bracket 13. The latch bracket 13 may movably support the latch 100.

The latch 100 may be provided to support the door 30 or not support the door 30. Specifically, when the cooking chamber 20 is closed by the door 30, the latch 100 may support the door 30 to prevent the door 30 from being opened, or may release the door 30 to allow the door 30 to be opened. The expression “the latch 100 releases the door 30” refers to a state in which the latch 100 is disengaged from door 30 and no longer supports the door 30, which is closing the cooking chamber 20.

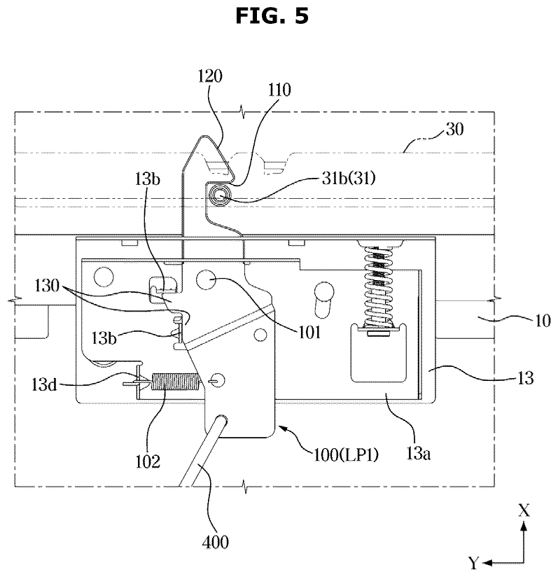

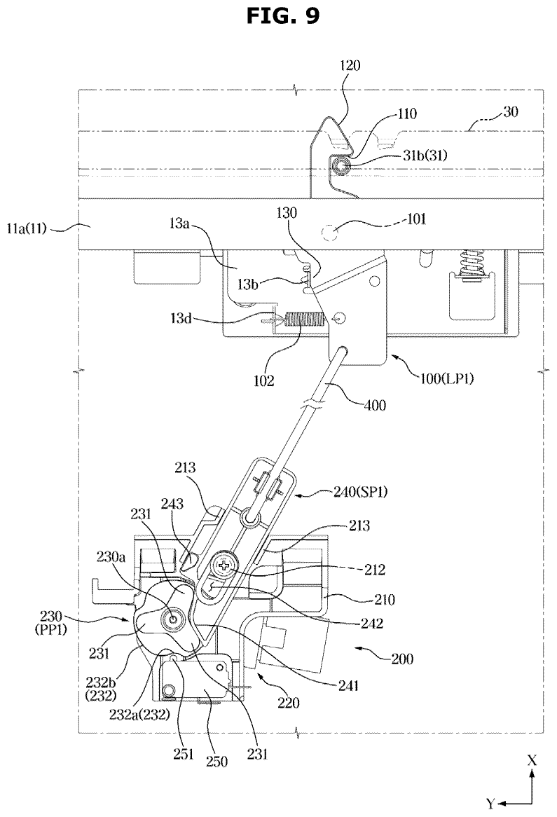

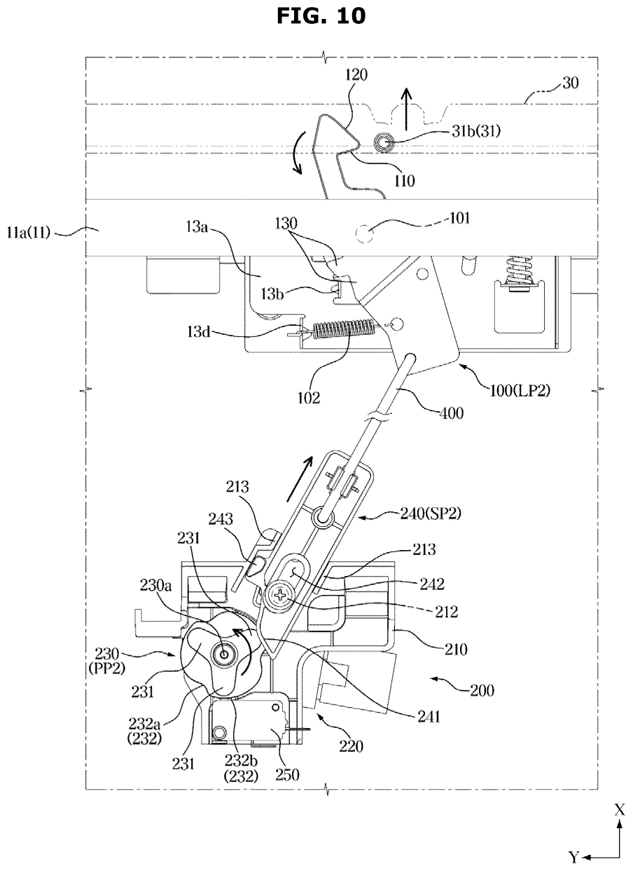

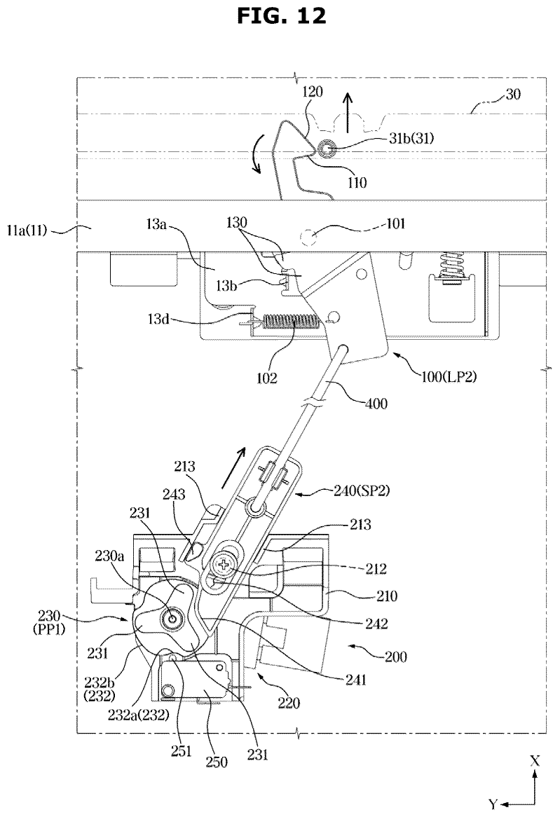

Hereinafter, a position of the latch 100 when the latch 100 supports the door 30 while the cooking chamber 20 is closed will be referred to as a first latch position LP1 (see FIG. 5, FIG. 9, etc.). Hereinafter, a position of the latch 100 when the latch 100 releases the door 30 while the cooking chamber 20 is closed will be referred to as a second latch position LP2 (see FIG. 10, FIG. 12, etc.). When the door 30 closes the cooking chamber 20, the latch 100 located at the first latch position LP1 may support the door 30 by being engaged with the door 30. When the door 30 closes the cooking chamber 20, the latch 100 may be disengaged from the door 30 to release the door 30 by moving from the first latch position LP1 to the second latch position LP2, and the door 30 may be opened.

The latch 100 may be provided to be moveable between the first latch position LP1 and the second latch position LP2.

The door 30 may include a door locking portion 31. The door locking portion 31 may be provided to be engaged with the latch 100 when the door 30 closes the cooking chamber 20 and the latch 100 is located at the first latch position LP1. In other words, the latch 100 may be caught on the door locking portion 31 in a case of being located at the first latch position LP1 when the cooking chamber 20 is closed. When the latch 100 is engaged with the door locking portion 31, the door 30 may be fixed in a position of closing the cooking chamber 20 by being supported by the latch 100.

When the latch 100 moves from the first latch position LP1 to the second latch position LP2, the latch 100 may be disengaged from the door locking portion 31. When the latch 100 is disengaged from the door locking portion 31, the latch 100 may release the door 30 and allow the door 30 to be opened.

The door locking portion 31 may include, for example, a door hole 31a formed such that a portion of the latch 100 may be inserted therein, and a locking pin 31b formed such that the latch 100 may be caught thereon. Specifically, when the door 30 closes the cooking chamber 20, a portion of the latch 100 may be inserted into an internal space of the door 30 by penetrating the door hole 31a. A portion of the latch 100 inserted into the internal space of the door 30 may be engaged with the locking pin 31b when the latch 100 is located at the first latch position LP1, and may support the locking pin 31b. When the latch 100 moves from the first latch position LP1 to the second latch position LP2, the latch 100 may be spaced apart from the locking pin 31b, and when the door 30 is rotated in an opening direction, the latch 100 may be disengaged from the door hole 31a.

The door hole 31a may be formed on an inner surface of the door 30, and the locking pin 31b may be disposed in the internal space of the door 30. Herein, the ‘inner surface of door 30’ refers to one surface of the door 30 facing the main body 10 when the door 30 closes the cooking chamber 20. As an example, the door hole 31a may be provided at an upper portion of the inner surface of the door 30 to correspond with the latch hole 11h provided in the main body 10.

As an example, as illustrated in FIG. 4, the locking pin 31b may be formed to have a substantially cylindrical shape, but is not limited thereto, and the locking pin 31b may have various shapes.

Unlike what is illustrated in FIG. 4, the door locking portion 31 may have various structures. For example, the door locking portion 31 may include a locking jaw structure formed on an edge side of the door hole 31a, and the latch 100 may be provided to support the door 30 by being engaged with the locking jaw structure.

Although an embodiment in which a portion of the latch 100 protrudes to the outside of the main body 10 and the door locking portion 31, particularly the locking pin 31b, is provided inside the door 30 is described above, unlike this, the door locking portion 31 may be formed to protrude from the inner surface of the door 30 toward the main body 10, and in this case, almost all portions of the latch 100 may be disposed inside the main body 10.

A detailed description of a structure and operation of the latch 100 will be described later.

The driving module 200 may be provided to move the latch 100 with respect to the main body 10. Specifically, the driving module 200 may be disposed to move the latch 100 from the first latch position LP1 to the second latch position LP2. Alternatively, the driving module 200 may be disposed to move the latch 100 from the second latch position LP2 to the first latch position LP1.

The driving module 200 may be disposed in the main body 10. Specifically, the driving module 200 may be disposed on a rear side of the main body 10. As an example, the driving module 200 may be mounted on the rear panel 11b of the main body 10. As such, when the driving module 200 is disposed on the rear side of the main body 10, a worker performing work such as repair, inspection, and parts replacement for the driving module 200 may easily access the driving module 200 by separating the rear cover 11c from the main body 10, thereby improving the convenience of the work.

The position of the driving module 200 is not limited thereto, and the driving module 200 may be disposed in various positions within the main body 10. For example, the driving module 200 may be disposed on the front side of the main body 10.

The driving module 200 may be disposed at the upper portion of the main body 10. At least portion of the driving module 200 may be disposed in the electrical room 50.

The driving module 200 may be fixed with respect to the main body 10. As an example, the driving module 200 may be fixed to the rear panel 11b of the main body 10. As an example, the driving module 200 may be fastened to the rear panel 11b by screws. However, the driving module 200 is not limited thereto, and may be coupled to various components within the main body 10 and fixed to the main body 10 in various ways.

As an example, the driving module 200 may include a driving module bracket 210 provided to be mounted to the main body 10. As an example, the driving module bracket 210 may be fixed with respect to the main body 10 by being coupled to the rear panel 11b.

A detailed description of a structure and operation of the driving module 200 will be described later.

The latch device of the cooking apparatus 1 may further include a connecting rod 400. The connecting rod 400 may connect the latch 100 and the driving module 200. Specifically, the connecting rod 400 may connect the latch 100 and a slider 240 of the driving module 200, which will be described later. The slider 240 and the latch 100 may move in conjunction with each other by being connected by the connecting rod 400. The connecting rod 400 may transmit a driving force generated from the driving module 200 to the latch 100.

As an example, the connecting rod 400 may be formed in the shape of a substantially long bar extending in one direction. However, the connecting rod 400 is not limited thereto and may have various shapes of connecting the latch 100 and the driving module 200 (specifically, the slider 240).

As an example, the latch 100 and the driving module 200 may be arranged substantially parallel to each other in a horizontal direction. In this case, the connecting rod 400 may extend substantially parallel to the horizontal direction between the latch 100 and the driving module 200.

The locking module 300 may be provided to restrain the latch 100 from moving from the first latch position LP1 to the second latch position LP2, or to allow the latch 100 from moving from the first latch position LP1 to the second latch position LP2. Specifically, the locking module 300 may include a locker 340. The locker 340 may be provided to restrain the latch 100 from moving from the first latch position LP1 to the second latch position LP2, or to allow the latch 100 from moving from the first latch position LP1 to the second latch position LP2. The latch 100 may be restricted from moving from the first latch position LP1 to the second latch position LP2, or may be capable of moving from the first latch position LP1 to the second latch position LP2, depending on a position of the locker 340.

For example, the locker 340 of the locking module 300 may be provided to restrain or allow the movement of the slider 240 of the driving module 200. The slider 240 may be restricted or allowed to move depending on the position of the locker 340.

The locking module 300 may be disposed in the main body 10. Specifically, the locking module 300 may be disposed on the rear side of the main body 10. As an example, the locking module 300 may be mounted on the rear panel 11b of the main body 10. As such, when the locking module 300 is disposed on the rear side of the main body 10, the worker performing work such as repair, inspection, and parts replacement for the locking module 300 may easily access the locking module 300 by separating the rear cover 11c from the main body 10, thereby improving the convenience of the work.

The position of the locking module 300 is not limited thereto, and the locking module 300 may be disposed in various positions within the main body 10. For example, the locking module 300 may be disposed on the front side of the main body 10. However, it is appropriate for the locking module 300 to be disposed adjacent to the driving module 200.

The locking module 300 may be disposed at the upper portion of the main body 10. At least portion of the locking module 300 may be disposed in the electrical room 50.

The locking module 300 may be fixed with respect to the main body 10. As an example, the locking module 300 may be fixed to the rear panel 11b of the main body 10. As an example, the locking module 300 may be fastened to the rear panel 11b by screws. However, the locking module 300 is not limited thereto, and may be coupled to various components within the main body 10 and fixed to the main body 10 in various ways.

As an example, the locking module 300 may include a locking module bracket 310 provided to be mounted to the main body 10. As an example, the locking module bracket 310 may be fixed with respect to the main body 10 by being coupled to the rear panel 11b.

As an example, the driving module 200 and the locking module 300 may be arranged in a substantially vertical direction Z. As illustrated in FIG. 3, the locking module 300 may be disposed above the driving module 200. Unlike this, the locking module 300 may be disposed below the driving module 200. Alternatively, the locking module 300 and the driving module 200 are not arranged in the vertical direction Z, but may be arranged in various ways in the main body 10.

FIG. 5 is a top view illustrating a portion of the main body and the latch mounted therein in the cooking apparatus according to an embodiment of the present disclosure.

Referring to FIG. 5, the latch 100 of the cooking apparatus 1 according to an embodiment of the present disclosure may be movably mounted on the main body 10. The latch 100 may be provided to be moveable between the first latch position LP1 and the second latch position LP2 (see FIGS. 10, 12, etc.).

Specifically, the latch 100 may be provided to be rotatable with respect to the main body 10. The latch 100 may be provided to be rotatable between the first latch position LP1 and the second latch position LP2 about a rotation axis of the latch 100. Referring to FIG. 5, the latch 100 may move to the second latch position LP2 by rotating counterclockwise from the first latch position LP1 about the rotation axis of the latch 100. Conversely, the latch 100 may move to the first latch position LP1 by rotating clockwise from the second latch position LP2 about the rotation axis of the latch 100. However, the rotational direction of the latch 100 is only an example, and the latch 100 may rotate in a direction opposite to the direction described above. Hereinafter, a direction in which the latch 100 rotates from the first latch position LP1 toward the second latch position LP2 about the rotation axis will be referred to as a first rotational direction, and a direction in which the latch 100 rotates from the second latch position LP2 toward the first latch position LP1 about the rotation axis will be referred to as a second rotational direction. First and second rotational directions are directions opposite to each other.

The latch 100 may be provided to be rotatable about a latch shaft 101 between the first latch position LP1 and the second latch position LP2. The rotation axis of the latch 100 may pass the latch shaft 101.

As an example, the latch shaft 101 may penetrate the latch 100. A hole is formed on the latch 100, and the latch shaft 101 may pass through the hole formed on the latch 100.

As an example, the latch shaft 101 may have a substantially cylindrical shape having the rotation axis of the latch 100 as a central axis thereof.

As an example, the rotation axis of latch 100 may be disposed parallel to the vertical direction Z. The latch shaft 101 may extend in the vertical direction Z.

The latch 100 may be provided to be rotatable with respect to the latch bracket 13. The latch bracket 13 may rotatably support the latch 100. The latch 100 may be coupled to the latch bracket 13 by the latch shaft 101.

The latch bracket 13 may include a bracket body 13a provided to support the latch 100. The latch 100 may be seated on the bracket body 13a. The latch 100 may be rotatably coupled to the bracket body 13a by the latch shaft 101.

The bracket body 13a may be mounted on the outer case 11. The bracket body 13a may be disposed inside the outer case 11. As an example, the bracket body 13a may be disposed in the electrical room 50. As an example, the bracket body 13a may be coupled to an inner wall of the front frame 11a.

The latch 100 may include a door support portion 110 provided to support the door 30. Specifically, when the door 30 closes the cooking chamber 20 and the latch 100 is located at the first latch position LP1, the door support portion 110 may support the door 30. The door support portion 110 may support the door 30 by being engaged with the door locking portion 31 of the door 30. The door support portion 110 may support the door 30 by being located at front of the locking pin 31b of the door locking portion 31 and coming into contact with the locking pin 31b.

Unlike this, when the door 30 closes the cooking chamber 20, as the latch 100 rotates from the first latch position LP1 to the second latch position LP2, the door support portion 110 may release the door 30. When the latch 100 moves from the first latch position LP1 to the second latch position LP2, the door support portion 110 may release the door 30 by being disengaged from the door locking portion 31. The door support portion 110 may release the door 30 by being spaced apart from the locking pin 31b.

As an example, the door support portion 110 may be provided on one end of the latch 100. Specifically, the door support portion 110 may be provided on one end of a front side of the latch 100.

As an example, the door support portion 110 may have a hook shape formed to be engaged with the door locking portion 31.

The latch 100 may include an inclined surface 120 provided to come into contact with the door locking portion 31 when the door 30 is closed. Specifically, the inclined surface 120 may be provided to be pressed by the locking pin 31b when the door 30 is closed.

When the door 30 is closed, the latch 100 may rotate as the inclined surface 120 is pressed by the locking pin 31b. Specifically, when the door 30 is closed, the latch 100 may rotate in the first rotational direction as the inclined surface 120 is pressed by the locking pin 31b, and as the latch 100 rotates in the first rotational direction, the locking pin 31b may move without being restricted by the latch 100 and the door 30 may be closed smoothly.

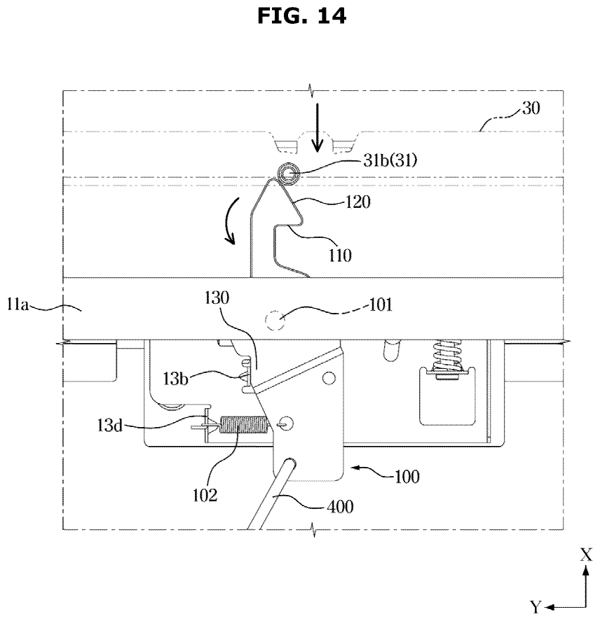

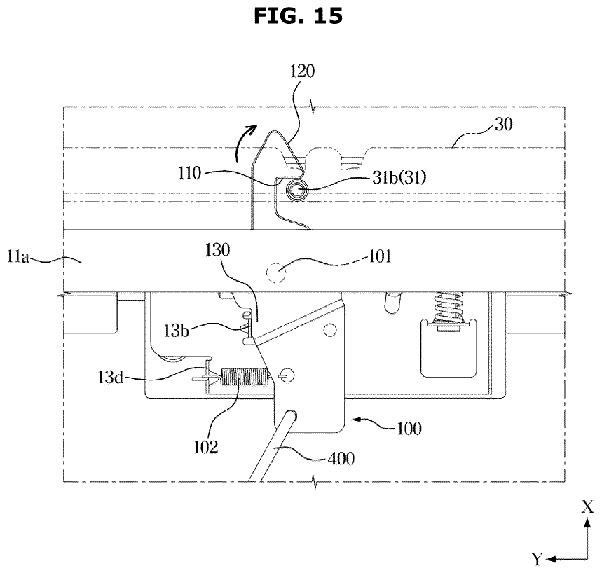

The inclined surface 120 may be provided on one end of the front side of the latch 100. Also, the inclined surface 120 may be positioned further forward than the door support portion 110. The inclined surface 120 may be a portion of the latch 100 that first comes into contact with the locking pin 31b when the door 30 is closed. The operation of the latch 100 when door 30 is closed will be described later with reference to FIGS. 14 and 15.

The latch device of the cooking apparatus 1 may include an elastic spring 102 connected to the latch 100. The elastic spring 102 may be provided to move the latch 100 to the first latch position LP1. In other words, the elastic spring 102 may be elastically biased to apply an elastic force to the latch 100 in a direction in which the latch 100 moves from the second latch position LP2 to the first latch position LP1. For example, when the latch 100 moves from the first latch position LP1 to the second latch position LP2, the elastic spring 102 may accumulate the elastic force while being deformed. When the force to locate the latch 100 in the second latch position LP2 is removed after the latch 100 has reached the second latch position LP2, the latch 100 may be returned to the first latch position LP1 by the elastic force accumulated in the elastic spring 102.

As an example, the elastic spring 102 may be a tension spring. However, the elastic spring 102 is not limited thereto, and may have various structures such as a compression spring and a torsion spring depending on a structure connected to the latch 100.

The elastic spring 102 may have one end connected to the latch 100 and the other end connected to the main body 10. Accordingly, when the latch 100 moves with respect to the main body 10, the elastic spring 102 may be deformed. As an example, the elastic spring 102 may have one end connected to the latch 100 and the other end connected to the latch bracket 13. The latch bracket 13 may include a spring coupling portion 13d to which the elastic spring 102 is connected. The elastic spring 102 may be deformed as a distance between the spring coupling portion 13d and the latch 100 changes.

As an example, the spring coupling portion 13d may be formed by bending a portion of the bracket body 13a.

As such, as the latch device includes the elastic spring 102, the latch 100 may be returned to the first latch position LP1 when the force to locate the latch in the second latch position LP2 is removed after the latch has moved to the second latch position LP2.

The main body 10 may include a latch stopper 13b provided to prevent the latch 100 from further rotating in the second direction from the first latch position LP1 when the latch 100 reaches the first latch position LP1. As an example, the latch stopper 13b may be provided on the latch bracket 13. As an example, the latch stopper 13b may be formed by bending a portion of the bracket body 13a.

The latch stopper 13b may be provided to come into contact with the latch 100 located at the first latch position LP1. The latch stopper 13b may be positioned on a side where the latch 100 rotates in the second rotational direction with respect to the latch 100 located at the first latch position LP1.

The latch 100 may include a stopper contact portion 130, and the stopper contact portion 130 may be provided to come into contact with the latch stopper 13b when the latch 100 is located at the first latch position LP1. The latch stopper 13b may be positioned on a side where the latch 100 rotates in the second rotational direction with respect to the stopper contact portion 130 when the latch 100 is located at the first latch position LP1. When the latch 100 rotates from the first latch position LP1 to the second latch position LP2, the stopper contact portion 130 may become away from the latch stopper 13b, and when the latch 100 rotates from the second latch position LP2 to the first latch position LP1, the stopper contact portion 130 may become close to the latch stopper 13b.

As such, as the latch stopper 13b is provided in the main body 10, the latch 100 may be guided to the first latch position LP1, and may be prevented from further rotating in the second rotational direction when the latch reaches the first latch position LP1. As described above, because the elastic spring 102 may be elastically biased to rotate the latch 100 in the second rotational direction, by the combination of the latch stopper 13b and the elastic spring 102, the latch 100 may be reliably located at the first latch position LP1 as long as a force is applied to locate the latch 100 in the second latch position LP2.

The latch 100 may be connected to the driving module 200 (specifically, the slider 240, which will be described later) by the connecting rod 400. The latch 100 may be coupled to the connecting rod 400. The latch 100 may be coupled to one end of the connecting rod 400.

As an example, the latch 100 may be rotatably coupled to one end of the connecting rod 400. The latch 100 is rotatable with respect to one end of the connecting rod 400, thereby preventing the rotation of the latch from being restricted or resisted by the connecting rod 400.

As an example, the connecting rod 400 may be coupled to a rear side of the latch 100.

As an example, the connecting rod 400 may penetrate the latch 100 and be coupled by being engaged with the latch 100. However, the latch 100 and the connecting rod 400 are not limited thereto and may be connected by various structures.

The structures of the latch 100 and the latch bracket 13 supporting the latch described above with reference to FIG. 5 are only an example, and the present disclosure is not limited thereto.

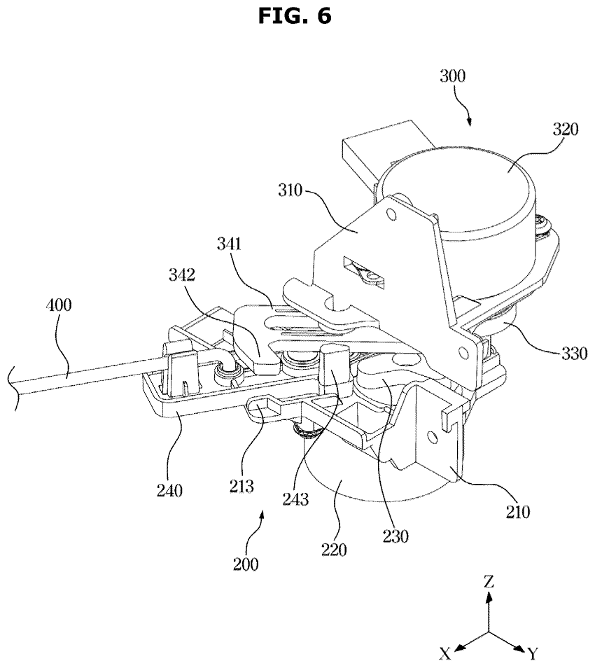

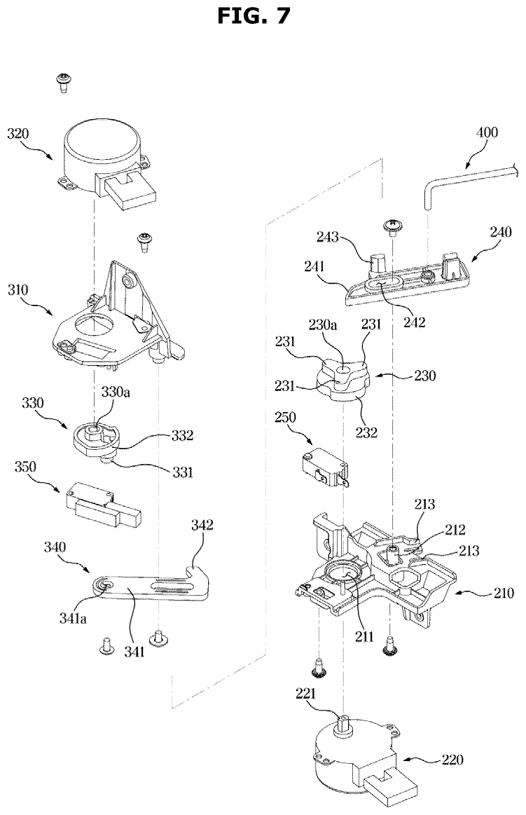

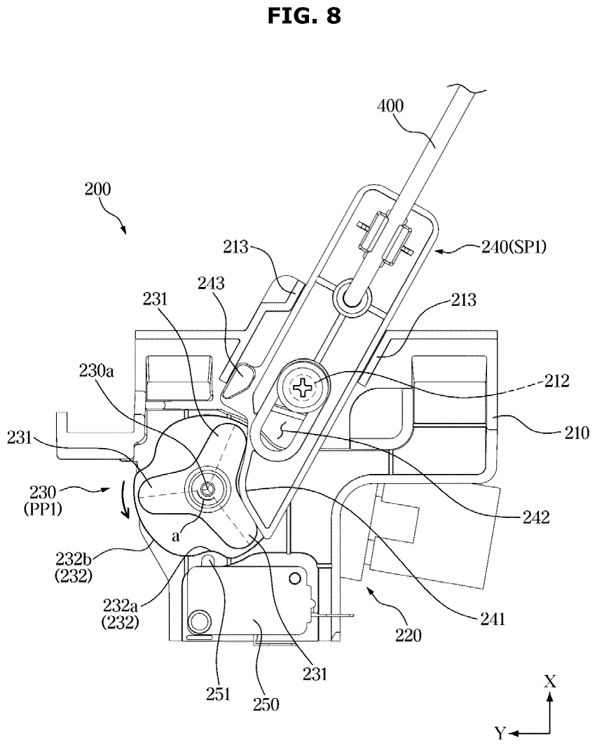

FIG. 6 is a view illustrating a driving module of the latch device in the cooking apparatus according to an embodiment of the present disclosure. FIG. 7 is an exploded view of the driving module of the latch device in the cooking apparatus according to an embodiment of the present disclosure. FIG. 8 is a top view illustrating components of the driving module, such as a slider, a connecting rod, and a pusher of the latch device, in the cooking apparatus according to an embodiment of the present disclosure.

Referring to FIGS. 6 to 8, the driving module 200 of the cooking apparatus 1 according to an embodiment of the present disclosure may include a pusher 230 provided to move the latch 100 from the first latch position LP1 to the second latch position LP2. The driving module 200 may include the slider 240 provided to be movable in conjunction with the latch 100. The pusher 230 may be provided to move the slider 240, and may move the latch 100 linked with the slider 240 by moving the slider 240.

Specifically, the slider 240 may be provided to be movable with respect to the main body 10. The slider 240 may be provided to be movable with respect to the driving module bracket 210. The slider 240 may be provided to be moveable between a first slider position SP1 (see FIG. 8) and a second slider position SP2 (see FIGS. 10 and 12).

The slider 240 may be connected to the latch 100. By being connected to the latch 100, the slider 240 may be moved between the first slider position SP1 and the second slider position SP2 when the latch 100 moves between the first latch position LP1 and the second latch position LP2. Herein, the first slider position SP1 is defined as a position of the slider 240 when the latch 100 is located at the first latch position LP1. The second slider position SP2 is defined as a position of the slider 240 when the latch 100 is located at the second latch position LP2.

The slider 240 may be connected to the latch 100 through the connecting rod 400. The slider 240 may be coupled to the connecting rod 400. The slider 240 may be coupled to one end of the connecting rod 400.

As an example, the connecting rod 400 may be coupled to a front side of the slider 240.

As an example, the connecting rod 400 may penetrate the slider 240 and be coupled by being engaged with the slider 240. Alternatively, as an example, the connecting rod 400 may be coupled by being engaged with a hook structure (see FIGS. 7 and 8) provided on the slider 240. However, the slider 240 and the connecting rod 400 are not limited thereto and may be connected by various structures.

The slider 240 may be mounted on the driving module bracket 210. The slider 240 may be movably mounted on the driving module bracket 210. The slider 240 may be movably supported by the driving module bracket 210.

The driving module 200 may include a first slider guide 212 provided to guide a movement of the slider 240. The first slider guide 212 may guide the slider 240 when the slider 240 moves between the first slider position SP1 and the second slider position SP2.

As an example, as illustrated in FIGS. 7 and 8, a slider rail 242 may be formed on the slider 240, and the first slider guide 212 may be inserted into the slider rail 242 to guide the movement of the slider 240. As an example, the slider rail 242 may be formed in the shape of a slot formed by cutting a portion of the slider 240.

Unlike this, as an example, a structure may be provided in which the first slider guide 212 has a rail shape and a portion of the slider 240 is inserted into the first slider guide 212 so that the slider 240 is guided by the first slider guide 212.

The first slider guide 212 may be fixed with respect to the main body 10. As an example, the first slider guide 212 may be provided on the driving module bracket 210.

The driving module 200 may include a second slider guide 213 provided to guide the movement of the slider 240. The second slider guide 213 may guide the slider 240 when the slider 240 moves between the first slider position SP1 and the second slider position SP2.

The second slider guide 213 may be fixed with respect to the main body 10. As an example, the second slider guide 213 may be provided on the driving module bracket 210.

As an example, the second slider guide 213 may have the shape of a rib protruding from one surface of the driving module bracket 210 on which the slider 240 is supported. The second slider guide 213 may guide the movement of the slider 240 by being in contact with a side surface of the slider 240. As an example, as illustrated in FIGS. 7 and 8, the second slider guide 213 is provided as a pair, and thus may guide the movement of the slider 240 by being in contact with both the side surfaces of the slider 240, respectively.

The slider 240 may be provided to be linearly movable with respect to the main body 10. The slider 240 may be provided to be linearly movable with respect to the driving module bracket 210. That is, the slider 240 may be provided to be linearly movable between the first slider position SP1 and the second slider position SP2. The first slider guide 212 and the second slider guide 213 may guide the slider 240 so that the slider 240 is linearly movable. The slider 240 may move linearly while being guided by the first slider guide 212 and the second slider guide 213.

However, the movement path of the slider 240 is not limited thereto, and for example, the slider 240 may be provided to move along a curved path. In this case, the structures of the second slider guide 213, the slider rail 242, and the like may have a curved shape corresponding to the movement path of the slider 240.

As an example, the slider 240 may be coupled to the first slider guide 212 of the driving module bracket 210. Specifically, the slider 240 may be mounted on the driving module bracket 210 as the first slider guide 212 is inserted into the slider rail 242 of the slider 240. In this case, the slider 240 and the first slider guide 212 may be firmly fastened to each other by a fastening member (e.g., a screw, etc.) penetrating the first slider guide 212.

The pusher 230 may be provided to press the slider 240. The pusher 230 may be provided to move the slider 240 from the first slider position SP1 to the second slider position SP2 by pressing the slider 240.

The pusher 230 may be located at a first pusher position PP1 (see FIG. 8). Or, the pusher 230 may be located at a second pusher position PP2 (see FIG. 10). The pusher 230 may be provided to be movable to the first pusher position PP1 or the second pusher position PP2.

The pusher 230 may not press the slider 240 when located at the first pusher position PP1. That is, the first pusher position PP1 is defined as a position at which the pusher 230 releases pressing on the slider 240. In other words, the pusher 230 may release pressing on the slider 240 to the second slider position SP2 when located at the The pusher 230 may be provided to move the slider 240, which is located at the first slider position SP1, to the second slider position SP2 when moving from the first pusher position PP1 to the second pusher position PP2. The pusher 230 may move the slider 240, which is located at the first slider position SP1, to the second slider position SP2 by pressing one end 241 of the slider 240 adjacent to the pusher 230 while moving from the first pusher position PP1 to the second pusher position PP2. Accordingly, the latch 100 linked with the slider 240 may move from the first latch position LP1 to the second latch position LP2.

The pusher 230 may release the slider 240 from pressing to the second slider position SP2 when moving from the second pusher position PP2 to the first pusher position PP1. As illustrated in FIGS. 7 and 8, the pusher 230 and the slider 240 may be configured to be separated from each other without being coupled to each other. That is, the slider 240 may be provided to be movable with respect to the pusher 230. Therefore, as will be described later, even though the pusher 230 is located at the first pusher position PP1 and does not press the slider 240, the slider 240 does not necessarily have to be located at the first slider position SP1, the slider 240 may be located at the second slider position SP2, and the latch 100 may also be located at the second latch position LP2.

The first pusher position PP1 is defined as a position at which the pusher 230 does not press the slider 240, and the first pusher position PP1 of the pusher 230 is not necessarily defined as one specific position. The second pusher position PP2 is defined as a position at which the pusher 230 presses the slider 240, and the second pusher position PP2 of the pusher 230 is not necessarily defined as one specific position. For example, as will be described later, the pusher 230 may include a plurality of contact portions 231, and the plurality of contact portions 231 may be provided to press the slider 240 one by one. Accordingly, a position at which any one of the plurality of contact portions 231 presses the slider 240 may be defined as the second pusher position PP2. Herein, the number of the second pusher positions PP2 may correspond to the number of the contact portions 231. The first pusher position PP1 may be defined as a position when none of the plurality of contact portions 231 press the slider 240, and the first pusher position PP1 may be defined as a position between the second pusher positions PP2. Herein, the number of first pusher positions PP1 may correspond to the number of regions between the plurality of contact portions 231.

The pusher 230 may be provided to be rotatable with respect to the main body 10. The pusher 230 may be provided to be rotatable with respect to the driving module bracket 210. The pusher 230 may be provided to be rotatable about a rotation axis 230a of the pusher 230. As an example, the rotation axis 230a of the pusher 230 may extend parallel to the vertical direction Z, but a direction in which the rotation axis 230a of the pusher 230 extends is not limited thereto. The pusher 230 may rotate from the first pusher position PP1 to the second pusher position PP2 about the rotation axis 230a. Alternatively, the pusher 230 may rotate from the second pusher position PP2 to the first pusher position PP1 about the rotation axis 230a.

As an example, the pusher 230 may be provided to rotate in one direction about the rotation axis 230a. That is, a direction in which the pusher 230 rotates from the first pusher position PP1 toward the second pusher position PP2 and a direction in which the pusher 230 rotates from the second pusher position PP2 to the first pusher position PP1 may be the same. Hereinafter, one direction in which the pusher 230 rotates about the rotation axis 230a will be referred to as the ‘pusher rotation direction.’

The pusher 230 may include the contact portion 231 provided to press the slider 240 when the pusher 230 rotates from the first pusher position PP1 to the second pusher position PP2. The contact portion 231 may be provided to press the slider 240 from the first slider position SP1 toward the second slider position SP2 while coming into contact with the slider 240 when the pusher 230 rotates from the first pusher position PP1 to the second pusher position PP2.

As an example, the contact portion 231 may extend in a radial direction of the pusher 230 from the rotation axis 230a of the pusher 230.

The pusher 230 may include the plurality of contact portions 231. When the pusher 230 rotates from the first pusher position PP1 to the second pusher position PP2, at least some of the plurality of contact portions 231 may come into contact with the slider 240 and press the slider 240 to the second slider position SP2. As an example, when the pusher 230 rotates from the first pusher position PP1 to the second pusher position PP2, the plurality of contact portions 231 may press the slider 240 to the second slider position SP2 one by one. The plurality of contact portions 231 may be arranged along a rotational direction of the pusher 230. As the pusher 230 rotates in the pusher rotation direction, the plurality of contact portions 231 may come into contact with the slider 240 in the arranged order and press the slider 240.

As illustrated in FIG. 8, when the pusher 230 is located at the first pusher position PP1 and the slider 240 is located at the first slider position SP1, the slider 240 may be located between a pair of the contact portions 231 adjacent to each other among the plurality of contact portions 231. When the pusher 230 rotates in the pusher rotation direction from the first pusher position PP1 to the second pusher position PP2, one of the plurality of contact portions 231 may press the slider 240 to the second slider position SP2 (see FIG. 10). When the pusher 230 reaches the second pusher position PP2 by rotating again in the pusher rotation direction from the second pusher position PP2 and the slider 240 returns again to the first slider position SP1, the slider 240 may again be located between a pair of the contact portions 231 adjacent to each other among a plurality of contact portions 231, as illustrated in FIG. 8.

As an example, as illustrated in FIG. 8, the plurality of contact portions 231 may be arranged at a regular interval from each other. The plurality of contact portions 231 may be arranged such that directions in which the plurality of contact portions 231 extends about the rotation axis 230a, respectively, have a constant angle (a) therebetween. Herein, the angle (a) therebetween refers to an angle between the directions in which a pair of the contact portions 231 adjacent to each other among the plurality of contact portions 231 extends from the rotation axis 230a, respectively. The direction in which each of the contact portions 231 extends from the rotation axis 230a may be defined as a direction from the rotation axis 230a toward an outer end of the contact portion 231. In the embodiment illustrated in FIG. 8 as an example, the pusher 230 may include the three contact portions 231, and the angle (a) between the two adjacent contact portions 231 may be substantially 120 degrees. In this structure, when the pusher 230 located at the first pusher position PP1 rotates by the angle (a) therebetween in the pusher rotation direction, the pusher 230 may again be located at the first pusher position PP1. Also, when the pusher 230 located at the second pusher position PP2 rotates by the angle (a) therebetween in the pusher rotation direction, the pusher 230 may again be located at the second pusher position PP2. That is, the pusher 230 may be repeatedly located at the first pusher position PP1 each time the pusher rotates by the angle (a) therebetween, and may be repeatedly located at the second pusher position PP2 each time the pusher rotates by the angle (a) therebetween.

By this structure, the pusher 230 may move to the first pusher position PP1 or to the second pusher position PP2 while rotating at a constant speed. That is, the pusher 230 may press or release the pressing on the slider 240 while rotating at the constant speed.

The number of the contact portions 231 included in the pusher 230 may be designed differently depending on revolutions per minute (rpm) of a first driving source 220 connected to the pusher 230. Specifically, in order to maintain an operating time of the latch 100 within a predetermined range, it is appropriate to design the number of the contact portions 231 included in the pusher 230 to be larger as the revolutions per minute (rpm) of the first driving source 220 decreases, and correspondingly thereto, the angle (a) between a pair of the adjacent contact portions 231 among the plurality of contact portions 231 may decrease.

As an example, the plurality of contact portions 231 may be connected to each other and formed integrally. Unlike this, the plurality of contact portions 231 may be formed to be separated from each other.

By this configuration, the pusher 230 may move the slider 240 from the first slider position SP1 to the second slider position SP2.

Unlike what has been described above, the pusher 230 may be provided to rotate in one direction from the first pusher position PP1 toward the second pusher position PP2 and to rotate in the other direction from the second pusher position PP2 toward the first pusher position PP1, which is opposite to the one direction.

As such, the driving module 200 may include the first driving source 220 in order to provide the pusher 230 with a driving force for moving the pusher 230 with respect to the main body 10. The first driving source 220 may be provided to generate a driving force. The first driving source 220 may be provide to provide the generated driving force to the pusher 230.

As an example, the first driving source 220 may include a motor. The first driving source 220 may include various known types of motors.

As an example, the first driving source 220 may receive driving current from a motor driver through a wire or the like.

The first driving source 220 may provide the driving force to the pusher 230 by being directly or indirectly connected to the pusher 230. As an example, the first driving source 220 may be connected to the pusher 230 through a rotor shaft 221. The first driving source 220 may provide the driving force to the pusher 230 through the rotor shaft 221. The pusher 230 may rotate with respect to the main body 10 by receiving the driving force from the rotor shaft 221.

As an example, the first driving source 220 may be mounted on the driving module bracket 210. As an example, the first driving source 220 may be fixed to one side of the driving module bracket 210, and the pusher 230 may be disposed on the other side of the driving module bracket 210. The pusher 230 may be connected to the first driving source 220 through the rotor shaft 221 penetrating a rotor shaft penetration portion 211 formed on the driving module bracket 210.

The driving module 200 may include a pusher position detection sensor 250 provided to detect a position of the pusher 230. The pusher position detection sensor 250 may be provided to output an electrical signal corresponding to the position of the pusher 230.

For example, as illustrated in FIG. 8, the pusher position detection sensor 250 may include a switch 251 provided to generate an electrical signal depending on whether or not the pressing is present. In other words, an electrical signal output from the pusher position detection sensor 250 when the switch 251 is pressed and an electrical signal output from the pusher position detection sensor 250 when the switch 251 is not pressed may be different from each other. As an example, the pusher position detection sensor 250 may include a micro switch.

The pusher 230 may press the switch 251 or may not press the switch 251 depending on the position thereof. The pusher 230 may include a cam surface 232 formed along an outer circumference of the pusher 230. The cam surface 232 may press the switch 251 or may not press the switch 251 as the pusher 230 rotates about the rotation axis 230a. As an example, the cam surface 232 may be provided to not press the switch 251 by being spaced apart from the switch 251 when the pusher 230 is located at the first pusher position PP1 and to press the switch 251 when the pusher 230 is located at the second pusher position PP2. Conversely, the cam surface 232 may be provided to press the switch 251 when the pusher 230 is located at the first pusher position PP1 and to not press the switch 251 by being spaced apart from the switch 251 when the pusher 230 is located at the second pusher position PP2.

In addition, the pusher position detection sensor 250 may include various types of sensors, such as a hall sensor, a magnetic field sensor such as a reed switch, and an optical sensor.

By this configuration, the pusher position detection sensor 250 may be provided to detect whether the pusher 230 is located at the first pusher position PP1 or the second pusher position PP2. The pusher position detection sensor 250 may output an electrical signal for the position of the pusher 230, and a controller of the cooking apparatus 1 may control the first driving source 220 based on the electrical signal received from the pusher position detection sensor 250.

A detailed description of the features of detecting the position of the pusher 230 using the pusher position detection sensor 250 will be described later.

By this configuration, the driving module 200 may move the latch 100 from the first latch position LP1 to the second latch position LP2 by using components such as the first driving source 220, the pusher 230, and the slider 240, and the door 30 may be opened. As will be described later, the slider 240 may move together with the latch 100 even though the first driving source 220 does not operate and the pusher 230 does not rotate, so that the door 30 may be opened when the user applies a sufficient force to the door 30. However, in various cases for the safety of the user, the door 30 may need to be more firmly secured in the closed position, and to this end, the cooking apparatus 1 according to an embodiment may include the locking module 300 provided to completely lock the door 30 by restricting the movement of the latch 100 and the slider 240.

The locking module 300 may include the locker 340 provided to restrain the movement of the slider 240 or allow the movement of the slider 420. Specifically, the locker 340 may restrain the slider 240 from moving from the first slider position SP1 to the second slider position SP2 or may allow the slider 240 to move from the first slider position SP1 to the second slider position SP2.

The locker 340 may be provided to be movable with respect to the main body 10. The locker 340 may restrain the slider 240 from moving from the first slider position SP1 to the second slider position SP2 or allow the slider 240 to move from the first slider position SP1 to the second slider position SP2, depending on a relative position therebetween with respect to the main body 10. Hereinafter, for convenience, a position of the locker 340 when the locker 340 restrains the above movement of the slider 240 will be referred to as a locking position, and the position of the locker 340 when the locker 340 allows the above movement of the slider 240 will be referred to as an unlocking position. That is, the locker 340 may be provided to be movable between the locking position and the unlocking position with respect to the main body 10. The locker 340 may be provided to be movable between the locking position and the unlocking position with respect to the locking module bracket 310.

The locker 340 may be provided to be engaged with the slider 240 when the slider 240 is located at the first slider position SP1 and the locker 340 is located at the locking position. The locker 340 may include a locker body 341 and a hook portion 342 protruding from the locker body 341. The hook portion 342 may be provided to be engaged with the slider 240 when the slider 240 is located at the first slider position SP1 and the locker 340 is located at the locking position.

Specifically, the slider 240 may include a catch portion 243. The hook portion 342 and the catch portion 243 may be provided to come into contact with each other when the slider 240 is located at the first slider position SP1 and the locker 340 is located at the locking position. In this case, the hook portion 342 may be located in a direction in which the slider 240 moves from the first slider position SP1 to the second slider position SP2 with respect to the catch portion 243, and therefore, the hook portion 342 may interfere with the catch portion 243 to restrain the slider 240 from moving to the second slider position SP2.

As an example, when the slider 240 is located at the first slider position SP1 and the locker 340 is located at the locking position, the hook portion 342 may restrain the movement of the slider 240 by coming into contact with the catch portion 243 in front of the catch portion 243.

The hook portion 342 may protrude from one end of the rocker body 341. As an example, the rocker body 341 may extend in one direction, and the hook portion 342 may protrude from one end in one direction of the rocker body 341 in a direction different from the one direction of the rocker body 341.

As an example, the hook portion 342 may protrude in the horizontal direction from a front end of the rocker body 341.

The locking module 300 may include a second driving source 320 provided to generate a driving force for moving the locker 340 with respect to the main body 10. As an example, the second driving source 320 may include a motor. The second driving source 320 may include various known types of motors. As an example, the second driving source 320 may receive driving current from a motor driver through a wire or the like.

As an example, the second driving source 320 may be mounted on the locking module bracket 310.

The locking module 300 may include a locking cam 330. The locking cam 330 may move the locker 340 between the locking position and the unlocking position using the driving force received from the second driving source 320.

Specifically, the locking cam 330 may be provided to be rotatable with respect to the main body 10. The locking cam 330 may be provided to be rotatable with respect to the locking module bracket 310. The locking cam 330 may be provided to be rotatable about a cam rotation axis 330a. As an example, the cam rotation axis 330a may extend substantially parallel to the vertical direction Z. However, the cam rotation axis 30a is not limited thereto and may extend in various directions.

The locking cam 330 may receive the driving force generated from the second driving source 320. The locking cam 330 may be provided to be rotatable by the driving force generated from the second driving source 320. The locking cam 330 may receive the driving force by being connected to a rotor shaft of the second driving source 320.

The rotation axis of the locking cam 330 may be provided to be parallel to the rotor shaft of the second driving source 320. The rotation axis of the locking cam 330 may be disposed substantially on a straight line with the rotor shaft of the second driving source 320.

The locker 340 may be connected to the locking cam 330. Specifically, the locking cam 330 may be connected to the locker body 341. The locker body 341 may include a connecting portion 341a connected to the locking cam 330. The locking cam 330 may include a locker connecting shaft 331 connected to the connecting portion 341a. When the locking cam 330 rotates, the rocker 340 may move by receiving the driving force through the rocker connecting shaft 331.

The rocker connecting shaft 331 may be parallel to the cam rotation shaft 330a. The rocker connecting shaft 331 may be disposed to be apart from the cam rotation shaft 330a.

The locker 340 may be provided to be rotatably about the locker connecting shaft 331. Therefore, the rotation axis of the rocker 340 may be disposed to be apart from the cam rotation axis 330a. Accordingly, a rotational motion of the locking cam 330 may be converted into a substantially linear motion of the locker 340.

The locking cam 330 may be provided to rotate in one direction about the cam rotation axis 330a. In other words, a direction in which the locking cam 330 rotates about the cam rotation axis 330a when the locker 340 moves from the unlocking position to the locking position and a direction in which the locking cam 330 rotates about the cam rotation axis 330a when the locker 340 moves from the locking position to the unlocking position may be the same. Hereinafter, one direction in which the locking cam 330 rotates about the cam rotation axis 330a will be referred to as a ‘cam rotation direction.’ For example, as the locking cam 330 rotates in the cam rotation direction about the cam rotation axis 330a, the locker 340, which is located at the unlocking position, may move to the locking position. Also, as the locking cam 330 rotates in the cam rotation direction about the cam rotation axis 330a, the locker 340, which is located at the locking position, may move to the unlocking position.

Unlike this, as an example, the direction in which the locking cam 330 rotates about the cam rotation axis 330a when the locker 340 moves from the unlocking position to the locking position and the direction in which the locking cam 330 rotates about the cam rotation axis 330a when the locker 340 moves from the locking position to the unlocking position may be opposite to each other.

The locking module 300 may include a cam position detection sensor 350 provided to detect a position of the locking cam 330. The cam position detection sensor 350 may be provided to output an electrical signal corresponding to the position of the locking cam 330.

For example, the cam position detection sensor 350 may include a switch provided to generate an electrical signal depending on whether or not the pressing is present. The locking cam 330 may include a cam surface 332 provided on an outer circumference thereof, and the cam surface 232 may press or may not press the switch of the cam position detection sensor 350 as the locking cam 330 rotates. Because the position of the locking cam 330 is aligned with the position of the locker 340, the controller of the cooking apparatus 1 may control the second driving source 320 based on the electrical signal received from the cam position detection sensor 350.

The explanation about the driving module 200 and the locking module 300 included in the latch device of the cooking apparatus 1 according to an embodiment of the present disclosure has been described above with reference to FIGS. 6 to 8. However, unlike what has been explained above, the cooking apparatus 1 may not be provided with the locking module 300 including components such as the locker 340 in order to restrain the movement of the latch 100 or the slider 240, and in this case, the slider 240 of the driving module 200 may not be restricted in the movement from the first slider position SP1 to the second slider position SP2, and the latch 100 may not be restricted in the movement from the first latch position LP1 to the second latch position LP2.

Hereinafter, an operation of the latch device of the cooking apparatus 1 according to an embodiment of the present disclosure will be described with reference to FIGS. 9 to 15, based on a state in which the locker 340 of the locking module 300 unlocks the movement of the slider 240.

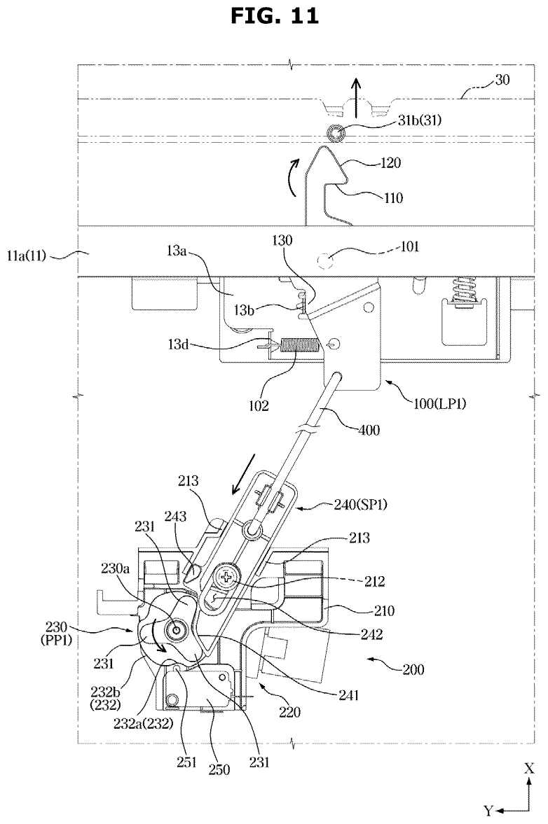

FIG. 9 is a view illustrating a state of the latch device when the door is closed in the cooking apparatus according to an embodiment of the present disclosure. FIG. 10 is a view illustrating that the latch device is operating to open the door in the cooking apparatus according to an embodiment of the present disclosure. FIG. 11 is a view illustrating that the latch device is operating such that the latch is returned to an original position thereof after being disengaged from a door locking portion in the cooking apparatus according to an embodiment of the present disclosure.

Referring to FIGS. 9 to 11, the cooking apparatus 1 according to an embodiment of the present disclosure may be configured such that the door 30 may be automatically opened by the operations of the driving module 200 and the latch 100.

Referring to FIG. 9, when the door 30 closes the cooking chamber 20 and the latch 100 is located at the first latch position LP1, the latch 100 may support the door 30 from being opened. At this time, the latch 100 may be in a state of being engaged with the door locking portion 31.

Specifically, when the door 30 closes the cooking chamber 20 and the latch 100 is located at the first latch position LP1, the latch 100 may come into contact with the locking pin 31b of the door locking portion 31. When the door 30 closes the cooking chamber 20 and the latch 100 is located at the first latch position LP1, the latch 100 may come into contact with a front side of the locking pin 31b.

For example, the door 30 may have a tendency to rotate in a direction of opening by a self-weight thereof. Or, for example, the hinge 40 may include a structure (e.g., including an elastic spring, etc.) of applying a force to the door 30 in a direction in which the door 30 is opened so that the door 30 may be easily opened. By this structure, the door 30 may have a tendency to rotate in the direction of opening. Therefore, in a case in which the latch 100 is located at the first latch position LP1 when the door 30 closes the cooking chamber 20, the locking pin 31b provided on the door 30 may come into contact with the latch 100, and accordingly, the latch 100 may support the door 30.

As described above, when the latch 100 is located at the first latch position LP1, the slider 240 may be located at the first slider position SP1 correspondingly. In an embodiment, when the slider 240 is located at the first slider position SP1, even though the pusher 230 is located at the first pusher position PP1 and does not press the slider 240, the pusher 230 and the slider 240 may come into contact with each other. In an embodiment, when the slider 240 is located at the first slider position SP1, the one end 241 of the slider 240 may be located between a pair of the contact portions 231 among the plurality of contact portions 231. In an embodiment, when the slider 240 is located at the first slider position SP1, the one end 241 of the slider 240 may come into contact with at least some of the plurality of contact portions 231.

As an example, the shape of the one end 241 adjacent to the pusher 230 of the slider 240 may be formed into a shape corresponding to the region between a pair of the contact portions 231 among the plurality of contact portions 231.

Unlike this, the slider 240 may be disposed to be spaced apart from the pusher 230 when located at the first slider position SP1, and in this case, a distance between the slider 240 and the pusher 230 is sufficient as long as it is within a distance that allows the pusher 230 to press the slider 240 as the pusher 230 moves from the first pusher position PP1 to the second pusher position PP2.

As illustrated in FIG. 10, when the pusher 230 rotates from the first pusher position PP1 to the second pusher position PP2, the slider 240 may move from the first slider position SP1 to the second slider position SP2 by being pressed by the pusher 230.

As an example, the slider 240 may be provided to be linearly movable between the first slider position SP1 and the second slider position SP2.

As an example, the second slider position SP2 may be located further in front than the first slider position SP1, and the slider 240 at the first slider position SP1 may move forward toward the second slider position SP2.

As an example, the slider 240 may move in a direction of becoming close to the rotation axis of the latch 100 when moving from the first slider position SP1 to the second slider position SP2. Conversely, the slider 240 may move in a direction of becoming away from the rotation axis of the latch 100 when moving from the second slider position SP2 to the first slider position SP1.

However, the relative position between the first slider position SP1 and the second slider position SP2 may vary depending on a connection structure between the latch 100 and the slider 240. For example, unlike what is illustrated in FIGS. 9 to 11, depending on the connection structure between the latch 100 and the slider 240, the first slider position SP1 may be located further in front than the second slider position SP2, and the first slider position SP1 and the second slider position SP2 may be located parallel to each other in a left-right direction.

As the slider 240 moves from the first slider position SP1 to the second slider position SP2, the latch 100 may move from the first latch position LP1 to the second latch position LP2. The latch 100 may be disengaged from the door locking portion 31 as the latch moves to the second latch position LP2. In this case, as described above, because the door 30 may have a tendency to rotate in the direction of opening by the self-weight thereof or the like, the door may open by itself without any external force being applied. Alternatively, the cooking apparatus 1 may have a separate structure of inducing the opening of the door 30 when the latch 100 moves to the second latch position LP2.

Because the slider 240 comes into contact with the pusher 230 while the pusher 230 is located at the second pusher position PP2, the slider 240 is located at the second slider position SP2, and the latch 100 is located at the second latch position LP2.

As illustrated in FIG. 11, when the door 30 is opened and the pusher 230 moves from the second pusher position PP2 to the first pusher position PP1, the latch 100 may be returned from the second latch position LP2 to the first latch position LP1 by a restoring force of the elastic spring 102. The slider 240 connected to the latch 100 may be returned from the second slider position SP2 to the first slider position SP1.

As described above, the driving module 200 may be provided with the pusher position detection sensor 250, and as an example, the pusher position detection sensor 250 may include the switch 251 provided to generate an electrical signal depending on whether or not the pressing is present. The pusher 230 may or may not press the switch 251 depending on the position thereof. The pusher 230 may or may not press the switch 251 while rotating about the rotation axis 230a. Specifically, while the pusher 230 rotates about the rotation axis 230a, the cam surface 232 of the pusher 230 may or may not press the switch 251.

For example, a circuit of the pusher position detection sensor 250 may become a turned-on state when the switch 251 is pressed and a turned-off state when the switch 251 is not pressed. Or, for example, the circuit of the pusher position detection sensor 250 may become the turned-on state when the switch 251 is not pressed and the turned-off state when the switch 251 is pressed. This may vary depending on how the circuit of the pusher position detection sensor 250 is configured.

The cam surface 232 of the pusher 230 may include a first region 232a and a second region 232b having a larger radius from the rotation axis 230a of the pusher 230 than the first region 232a. The first region 232a may have a groove shape of being concavely recessed toward the rotation axis 230a from the second region 232b. The second region 232b may protrude further outward from the radius of the pusher 230 than the first region 232a.

As an example, as illustrated in FIG. 9, the pusher 230 may be spaced apart from the switch 251 when located at the first pusher position PP1. That is, the pusher 230 may not press the switch 251 when located at the first pusher position PP1. Specifically, the first region 232a of the cam surface 232 may face the switch 251 when the pusher 230 is located at the first pusher position PP1, and may be formed so as not to press the switch 251 by being spaced apart from the switch 251. Based on the switch 251 not being pressed, the pusher position detection sensor 250 may detect that the pusher 230 is located at the first pusher position PP1. That is, based on the switch 251 not being pressed, the pusher position detection sensor 250 may output an electrical signal corresponding to the pusher 230 being located at the first pusher position PP1. The controller of the cooking apparatus 1, which is electrically connected to the pusher position detection sensor 250, may identify the position of the pusher 230 based on the electrical signal output from the pusher position detection sensor 250.

As illustrated in FIG. 10, the controller may drive the first driving source 220 based on a condition for opening the door 30 (a detailed content will be described later). As the first driving source 220 is driven, the pusher 230 may rotate in the pusher rotation direction from the first pusher position PP1, and the second region 232b faces the switch 251 and may press the switch 251. Based on the switch 251 being pressed, the pusher position detection sensor 250 may detect that the pusher 230 is rotating from the first pusher position PP1. That is, based on the switch 251 being pressed, the pusher position detection sensor 250 may output an electrical signal corresponding to the pusher 230 rotating from the first pusher position PP1. The controller of the cooking apparatus 1, which is electrically connected to the pusher position detection sensor 250, may continuously drive the first driving source 220 based on the electrical signal output from the pusher position detection sensor 250. Through this process, the pusher 230 may reach the second pusher position PP2, and the door 30 may be opened.

As illustrated in FIG. 11, the pusher 230 may continue to rotate in the pusher rotation direction after reaching the second pusher position PP2 to reach the first pusher position PP1. As an example, in the embodiment of FIGS. 9 to 11, the pusher 230 may rotate about 120 degrees from the first pusher position PP1 to reach the first pusher position PP1 again. When the pusher 230 reaches the first pusher position PP1, the first region 232a may face the switch 251, and the first region 232a may be formed so as not to press the switch 251 by being spaced apart from the switch 251. Based on the switch 251 not being pressed, the pusher position detection sensor 250 may detect that the pusher 230 is located at the first pusher position PP1. That is, based on the switch 251 not being pressed, the pusher position detection sensor 250 may output an electrical signal corresponding to the pusher 230 being located at the first pusher position PP1. The controller of the cooking apparatus 1, which is electrically connected to the pusher position detection sensor 250, may stop the first driving source 220 based on the electrical signal output from the pusher position detection sensor 250, and the pusher 230 may stop at the first pusher position PP1.

The operation of automatically opening the door 30 described above (hereinafter referred to as the ‘door opening operation’) may be performed based on the input of a door opening signal, which is a user input for opening the door 30.

As an example, the door opening signal may be input through the user interface 60. The configuration of the user interface 60 capable of receiving a door opening signal may include, but is not limited to, the input button 61 illustrated in FIGS. 1 and 2. The user interface 60 may transmit the input door opening signal to the controller of the cooking apparatus 1.

Alternatively, as an example, the cooking apparatus 1 may include a microphone module capable of detecting sound, and the door opening signal may be input through the microphone module. The microphone module may detect various types of sounds that the user may make using his or her body, such as voice of the user. The microphone module may transmit the input door opening signal to the controller of the cooking apparatus 1.

Alternatively, as an example, the cooking apparatus 1 may include a motion detection module to detect a motion of the user, and the door opening signal may be input through the motion detection module. The motion detection module may include various types of modules capable of detecting a motion of the user, such as a light sensor, such as an infrared sensor, and a camera module. The motion detection module may transmit the input door opening signal to the controller of the cooking apparatus 1.

Alternatively, as an example, the cooking apparatus 1 may include a communication module to communicate with an external electronic device. The communication module may communicate with the external electronic device using wired communication or wireless communication. The external electronic device may include a user terminal such as a smartphone. The external electronic device may include a server device. The external electronic device may transmit the door opening signal to the communication module of the cooking apparatus 1, and the communication module may process the received door opening signal and transmit the processed signal to the controller.

As an example, the door opening operation may be performed under a condition that the door 30 is in a state of being closed. Specifically, the cooking apparatus 1 may include a door opening detection sensor to detect whether or not the door 30 is opened. The door opening detection sensor may output an electrical signal corresponding to the opening or closing of the door 30 and transmit the output signal to the controller of the cooking apparatus 1. The controller of the cooking apparatus 1 may perform the door opening operation based on the door opening signal being input and the door 30 being closed.

As such, the controller receiving and processing the door opening signal may be composed of the same module as a controller driving the first driving source 220, or may be composed of a separate module.

There may be a case in which the door 30 must be opened even though the driving module 200 is not driven, either by a simple intention of the user or due to a need of the user. For example, there may be a case in which the driving module 200 does not operate due to reasons such as the first driving source 220 or components of the cooking apparatus 1 required to control the first driving source 220 being damaged, power supply to the cooking apparatus 1 being cut off, or components to receive the door opening signal of the user being damaged. In such a case, the door 30 must be able to be opened without repairing or replacing the components, etc. Therefore, in an embodiment, the slider 240 may be configured to be moveable from the first slider position SP1 to the second slider position SP2 even without the pressing of the pusher 230.

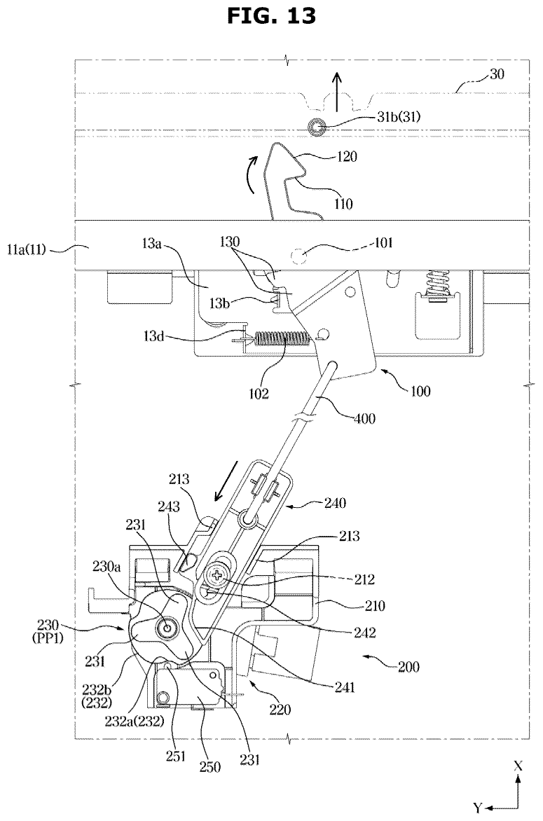

FIG. 12 is a view illustrating an operation of the latch device when the door is forcibly opened in a state in which the driving module does not operate in the cooking apparatus according to an embodiment of the present disclosure. FIG. 13 is a view illustrating that the latch is returning to the original position thereof after being disengaged from the door locking portion in the cooking apparatus according to an embodiment of the present disclosure.

Referring to FIGS. 12 and 13, in the cooking apparatus 1 according to an embodiment of the present disclosure, the slider 240 may be provided to be movable with respect to the pusher 230. Specifically, the slider 240 may be provided to be movable between the first slider position SP1 and the second slider position SP2 when the pusher 230 is located at the first pusher position PP1. The pusher 230 and slider 240 may be configured to be separate and not coupled to each other, and therefore, the slider 240 may be provided to be movable between the first slider position SP1 and the second slider position SP2 even though the pusher 230 does not press the slider 240 by being located at the first pusher position PP1.

The slider 240 may be provided to be movable between the first slider position SP1 and the second slider position SP2 when the pusher 230 is located at the first pusher position PP1. When the pusher 230 is located at the first pusher position PP1, the slider 240 may move in a direction of becoming away from the pusher 230 as the latch 100 moves from the first latch position LP1 to the second latch position LP2.

For example, when the user applies a force to the door 30 in the direction in which the door 30 is opened by grasping the handle 32, the locking pin 31b may press the door support portion 110 of the latch 100, as illustrated in FIG. 12. When a magnitude of the force applied to the door 30 in the opening direction reaches a certain level, the latch 100, which is located at the first latch position LP1 by the locking pin 31b, may rotate in the first rotational direction. For example, as illustrated in FIG. 12, the locking pin 31b and the latch shaft 101 may be provided to be spaced apart from each other in a left-right direction Y, and the latch 100 may rotate in the first rotational direction about the latch shaft 101 due to a torque generated by the locking pin 31b pressing the door support portion 110 forward.

At this time, the slider 240 connected to the latch 100 may move from the first slider position SP1 toward the second slider position SP2 as the latch 100 rotates in the first rotational direction even though the pusher 230 is in a stopped state. Therefore, the rotation of the latch 100 in the first rotational direction is not restricted by the slider 240, and the latch 100 may smoothly rotate to the second latch position LP2. When the latch 100 reaches the second latch position LP2, the latch 100 may be disengaged from the door locking portion 31 and the door 30 may be opened.

In the case of FIG. 12, an angle at which the latch 100 rotates in the first rotational direction from the first latch position LP1 toward the second latch position LP2 may be a minimum angle sufficient to disengage the latch 100 from the door locking portion 31. Therefore, in the case of FIG. 12, a rotation angle of the latch 100 may be less than or equal to a rotation angle of the latch 100 in the case of FIG. 10.

Similarly, in the case of FIG. 12, a distance that the slider 240 moves from the first slider position SP1 to the second slider position SP2 may be less than or equal to a distance the slider 240 moves from the first slider position SP1 to the second slider position SP2 in the case of FIG. 10.

As illustrated in FIG. 13, after the door 30 is opened and the latch 100 is completely disengaged from the door locking portion 31, the latch 100 may be returned from the second latch position LP2 to the first latch position LP1 by the restoring force of the elastic spring 102. The slider 240 connected to the latch 100 may be returned from the second slider position SP2 to the first slider position SP1.

As such, the slider 240 is configured to be separated from the pusher 230, so that the slider 240 may move with respect to the main body 10 even when the first driving source 220 is damaged or a power source is cut off, and therefore, the user may manually open the door 30 by applying a force greater than or equal to a certain magnitude to the door 30.

In addition, the slider 240 is configured to be separated from the pusher 230, so that the slider 240 may move more smoothly with respect to the main body 10, and in a process in which door 30 is opened or closed, the latch 100 may move to the latch positions more efficiently. In particular, because the slider 240 may move to the first slider position SP1 without being restricted by the pusher 230 when the pusher 230 is in the first pusher position PP1, the latch 100 may also move more smoothly to the first latch position LP1.

FIG. 14 is a view illustrating an operation of the latch when the door is closed in the cooking apparatus according to an embodiment of the present disclosure. FIG. 15 is a view illustrating an operation of the latch when the door is closed in the cooking apparatus according to an embodiment of the present disclosure.

Referring to FIGS. 14 and 15, in the cooking apparatus 1 according to an embodiment of the present disclosure may rotate the latch 100 by the door locking portion 31 when the door 30 is closed.

As an example, while the door 30 is closing, the latch 100 located at the first latch position LP1 may rotate in the first rotational direction by being pressed by the locking pin 31b. Specifically, the latch 100 may include the inclined surface 120 provided at a front end of the latch 100, and while the door 30 is closing, the locking pin 31b may press the inclined surface 120. The inclined surface 120 may be provided to be inclined with respect to the front-rear direction X of the main body 10. As illustrated in FIGS. 14 and 15, when the locking pin 31b is located on the left side with respect to the rotation axis of the latch 100, the inclined surface 120 may extend toward the left side of the main body 10 as the inclined surface faces rearward. Conversely, when the locking pin 31b is located on the right side with respect to the rotation axis of the latch 100, the inclined surface 120 may extend toward the right side of the main body 10 as the inclined surface faces rearward.

By this structure, the latch 100 located at the first latch position LP1 may efficiently rotate in the first rotational direction by being pressed by the locking pin 31b, and the door 30 may rotate in the closing direction without being restricted by the latch 100.

When the latch 100 rotates by being pressed by the locking pin 31b while the door 30 is closing, the slider 240 may move from the first slider position SP1 toward the second slider position SP2. Because the slider 240 is configured to be separated from the pusher 230, even though the pusher 230 does not rotate, the slider 240 may move toward the second slider position SP2, and the latch 100 may rotate smoothly in the first rotational direction.

Thereafter, as illustrated in FIG. 15, when the door 30 is closed, the door support portion 110 of the latch 100 may be inserted into the door locking portion 31. The latch 100 inserted into the door locking portion 31 may rotate in the second rotational direction by the restoring force of the elastic spring 102 when the latch is not pressed by the locking pin 31b. The latch 100 may reach the first latch position LP1 by rotating in the second rotational direction, and the door support portion 110 may support the locking pin 31b from the front. Accordingly, the latch 100 may secure the door 30 in the closed position.

When the latch 100 rotates in the second rotation direction, the slider 240 may move toward the first slider position SP1. Because the slider 240 is configured to be separated from the pusher 230, the slider 240 may move toward the first slider position SP1 even though the pusher 230 does not rotate, and the latch 100 may rotate smoothly in the second rotational direction. That is, the latch 100 may smoothly move to a position of supporting the door 30, and the door 30 may efficiently close the cooking chamber 20.

Unlike what has been described above with reference to FIGS. 1 to 15, in an embodiment, the connecting rod 400 connecting the latch 100 and the slider 240 may not be provided, and the latch 100 and slider 240 may be directly connected to each other.

In the embodiment of FIGS. 1 to 15, the slider 240 is configured to transmit the driving force from the pusher 230 to the latch 100, but unlike this, in an embodiment, in addition to the slider 240, another structure capable of transmitting the driving force from the pusher 230 to the latch 100 may be provided, or the pusher 230 may be configured to directly press the latch 100. That is, the latch 100 may have various structures configured to be moved from the first latch position LP1 to the second latch position LP2 when the pusher 230 moves from the first pusher position PP1 to the second pusher position PP2 and to be movable between the first latch position LP1 and the second latch position LP2 when the pusher 230 is located at the first pusher position PP1.

In the embodiment of FIGS. 1 to 15, the pusher 230 is configured to rotate about the fixed rotation axis 230a with respect to the main body 10, but is not limited thereto, and the pusher 230 may have various structures configured to be separated from the slider 240 and movable to a position where the slider 240 is pressed or a position where the slider 240 is not pressed.

In the above, the cooking apparatus according to an embodiment of the present disclosure has been described assuming that it is an oven, but the present disclosure is not limited thereto and may be applied to various types of cooking apparatus such as a microwave oven. In addition, the present disclosure may be applied to various types of home appliances and other devices to which a latch device configured to support or release a closed door may be applied.

A cooking apparatus according to an embodiment of the present disclosure may include a main body 10 forming a cooking chamber 20, a door 30 provided to open and close the cooking chamber 20 and including a door locking portion 31, a latch 100 mounted on the main body 10 and provided to be movable between a first latch position LP1 in which the latch is engaged with the door locking portion 31 and a second latch position LP2 in which the latch is disengaged from the door locking portion 31 when the cooking chamber 20 is closed, a slider 240 connected to the latch 100 and provided to be movable between a first slider position SP1 when the latch 100 is located at the first latch position LP1 and a second slider position SP2 when the latch 100 is located at the second latch position LP2, and a pusher 230 provided to press the slider 240 and to be movable to a first pusher position PP1 of releasing the pressing of the slider 240 or a second pusher position PP2 of pressing the slider 240. The pusher 230 may be provided to move the slider 240 from the first slider position SP1 to the second slider position SP2 when moving from the first pusher position PP1 to the second pusher position PP2. The slider 240 may be provided to be movable between the first slider position SP1 and the second slider position SP2 when the pusher 230 is located at the first pusher position PP1.

The slider 240 may be provided to be movable between the first slider position SP1 adjacent to the pusher 230 and the second slider position SP2 spaced apart from the pusher 230 when the pusher 230 is located at the first pusher position PP1.

The pusher 230 may be provided to rotate from the first pusher position PP1 to the second pusher position PP2 or rotate from the second pusher position PP2 to the first pusher position PP1 about a rotation axis 230a with respect to the main body 10.

The pusher 230 may be provided to rotate in one direction from the first pusher position PP1 toward the second pusher position PP2 about the rotation axis 230a of the pusher 230, and may be provided to rotate in the one direction from the second pusher position PP2 toward the first pusher position PP1 about the rotation axis 230a.

The pusher 230 may include a plurality of contact portions 231 extending in a radial direction from the rotation axis 230a of the pusher 230 and arranged along a rotational direction of the pusher 230. The plurality of contact portions 231 may be provided such that at least some of the plurality of contact portions 231 come into contact with the slider 240 and presses the slider 240 from the first slider position SP1 toward the second slider position SP2, when the pusher 230 rotates from the first pusher position PP1 to the second pusher position PP2.

The slider 240 may be provided such that when located at the first slider position SP1, one end 241 thereof adjacent to the pusher 230 is located between a pair of the contact portions 231 adjacent to each other among the plurality of contact portions 231.

One of the pair of contact portions 231 may be provided to press the one end 241 of the slider 240 when the pusher 230 rotates from the first pusher position PP1 to the second pusher position PP2.

The latch 100 may be provided to move from the second latch position LP2 to the first latch position LP1 when the pusher 230 moves from the second pusher position PP2 to the first pusher position PP1.

The cooking apparatus may further include an elastic spring 102 connected to the latch 100 and elastically biased to apply an elastic force to the latch 100 in a direction in which the latch 100 moves from the second latch position LP2 to the first latch position LP1.

The latch 100 may be provided to be rotatable between the first latch position LP1 and the second latch position LP2 about a rotation axis thereof. The slider 240 may move in a direction of becoming close to the rotation axis of the latch 100 when moving from the first slider position SP1 to the second slider position SP2. The slider 240 may move in a direction of becoming away from the rotation axis of the latch 100 when moving from the second slider position SP2 to the first slider position SP1.

The slider 240 may be provided to be linearly movable between the first slider position SP1 and the second slider position SP2.

The cooking apparatus may further include slider guides 212 and 213 fixed to the main body 10 and provided to guide the slider 240 so that the slider 240 moves linearly between the first slider position SP1 and the second slider position SP2.

The cooking apparatus may further include a pusher position detection sensor 250 provided to detect a position of the pusher 230.

The pusher position detection sensor 250 may include a switch 251 provided to generate an electrical signal depending on whether or not the pressing is present. The pusher 230 may be provided to be spaced apart from the switch 251 when located at the first pusher position PP1 and to press the switch 251 when moving from the first pusher position PP1 to the second pusher position PP2.

The cooking apparatus may further include a connecting rod 400 provided to connect the latch 100 and the slider 240.

A cooking apparatus according to an embodiment of the present disclosure may include a main body 10 forming a cooking chamber 20, a door 30 provided to open and close the cooking chamber 20, a latch 100 disposed in the main body 10 and provided to be rotatable between a first latch position LP1 of supporting the door 30 to prevent opening of the door 30 and a second latch position LP2 of releasing the door 30 to allow the door 30 to be opened when the door 30 closes the cooking chamber 20, a slider 240 disposed in the main body 10 and connected to the latch 100 to be movable in conjunction with a position of the latch 100 when the latch 100 rotates between the first latch position LP1 and the second latch position LP2, and a pusher 230 disposed in the main body 10 and provided to be rotatable to a first pusher position PP1 of releasing pressing of the slider 240 or a second pusher position PP2 of pressing the slider 240. The slider 240 may be provided to rotate the latch 100 from the first latch position LP1 to the second latch position LP2 when the pusher 230 moves from the first pusher position PP1 to the second pusher position PP2. The slider 240 may be provided to move in a direction of becoming away from the pusher 230 as the latch 100 rotates from the first latch position LP1 to the second latch position LP2 when the pusher 230 is located at the first pusher position PP1.

The slider 240 may be provided to be linearly movable between a position of being adjacent to the pusher 230 and a position of being spaced apart from the pusher 230 when the pusher 230 is located at the first pusher position PP1.

The pusher 230 may include a plurality of contact portions 231 arranged along a rotational direction of the pusher 230 and each extending in a radial direction from a rotation axis 230a of the pusher 230. The plurality of contact portions 231 may be provided to press the slider 240 when the pusher 230 rotates from the first pusher position PP1 to the second pusher position PP2.

The latch 100 may be provided to move to the second latch position LP2 by rotating in a first rotational direction from the first latch position LP1 and to move to the first latch position LP1 by rotating in a second rotational direction opposite to the first rotational direction from the second latch position LP2. The main body 10 may include a latch stopper 13b provided to prevent the latch 100 from further rotating in the second rotational direction from the first latch position LP1.

A cooking apparatus according to an embodiment of the present disclosure may include a main body 10 forming a cooking chamber 20, a door 30 provided to be rotatable with respect the main body 10 to open and close the cooking chamber 20 and including a door locking portion 31, a latch 100 disposed in the main body 10 and provided to be movable between a first latch position LP1 in which the latch is engaged with the door locking portion 31 and a second latch position LP2 in which the latch is disengaged from the door locking portion 31 when the cooking chamber 20 is closed, a driving source 220 disposed in the main body 10 and provided to generate a driving force, and a pusher 230 disposed in the main body 10 and provided to be movable between a first pusher position PP1 and a second pusher position PP2 by receiving the driving force from the driving source 220. The pusher 230 may be provided to move the latch 100 from the first latch position LP1 to the second latch position LP2 when moving from the first pusher position PP1 to the second pusher position PP2. The latch 100 may be provided to be movable between the first latch position LP1 and the second latch position LP2 when the pusher 230 is located at the first pusher position PP1.

According to the present disclosure, a cooking apparatus can provide a structure of automatically opening a door by including a slider connected to a latch and a pusher pressing the slider.

According to the present disclosure, the cooking apparatus can be configured such that the slider is separated from the pusher, so that the slider can move more smoothly with respect to a main body and the latch can move to a position thereof efficiently in a process in which the door is opened or closed.

According to the present disclosure, the cooking apparatus can be configured such that the slider is separated from the pusher, so that even when a driving module operate due to reasons such as damage to a driving source and power failure, the slider can move with respect to the main body, and therefore, a user can manually open the door even when the driving module does not operate.

Effects obtainable from the present disclosure are not limited to the effects mentioned above, and other effects not mentioned will be clearly understood by those skilled in the art from the description below.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

1. A cooking apparatus comprising:
a main body including a cooking chamber;
a door to open and close the cooking chamber and including a door locking portion;
a latch mounted on the main body and that is movable, with the cooking chamber closed, between a first latch position in which the latch is engaged with the door locking portion and a second latch position in which the latch is disengaged from the door locking portion;
a slider connected to the latch and that is movable between a first slider position corresponding to the first latch position and a second slider position corresponding to the second latch position; and
a pusher configured to press the slider and that is movable to a first pusher position of releasing the pressing of the slider and movable to a second pusher position of pressing the slider,
wherein the pusher is configured to move the slider from the first slider position to the second slider position with the pusher moved from the first pusher position to the second pusher position, so as to move the latch from the first latch position to the second latch position, and
wherein the slider is configured to be movable between the first slider position and the second slider position with the pusher located at the first pusher position, so as to correspondingly move the latch between the first latch position and the second latch position.

2. The cooking apparatus according to claim 1, wherein
with the slider moved to the first slider position, the slider is adjacent to the pusher, and with the slider moved to the second slider position and the pusher located at the first pusher position, the slider is spaced apart from the pusher.

3. The cooking apparatus according to claim 1, wherein
the pusher is rotatable with respect to the main body about a rotation axis of the pusher from the first pusher position to the second pusher position, and from the second pusher position to the first pusher position.

4. The cooking apparatus according to claim 3, wherein
the pusher is configured to rotate about the rotation axis of the pusher in a direction from the first pusher position toward the second pusher position, and from the second pusher position toward the first pusher position.

5. The cooking apparatus according to claim 3, wherein
the pusher includes a plurality of contact portions extending in a radial direction from the rotation axis of the pusher and that are arranged along a rotational direction of the pusher, and
the plurality of contact portions are configured so that, as the pusher is moved from the first pusher position to the second pusher position, at least one contact portion of the plurality of contact portions contacts the slider and presses the slider from the first slider position toward the second slider position.

6. The cooking apparatus according to claim 5, wherein
the slider is configured so that, with the slider moved to the first slider position, one end of the slider is adjacent to the pusher and is located between a pair of adjacent contact portions of the plurality of contact portions.

7. The cooking apparatus according to claim 6, wherein
one of the pair of adjacent contact portions is configured to press the one end of the slider as the pusher is rotated from the first pusher position to the second pusher position.

8. The cooking apparatus according to claim 1, wherein
the latch is configured to move from the second latch position to the first latch position as the pusher is moved from the second pusher position to the first pusher position.

9. The cooking apparatus according to claim 8, further comprising
an elastic spring connected to the latch and elastically biased to apply an elastic force to the latch in a direction in which the latch moves from the second latch position to the first latch position.

10. The cooking apparatus according to claim 1, wherein
the latch is configured to be rotatable about a rotation axis thereof between the first latch position and the second latch position, and
as the slider is moved from the first slider position to the second slider position, the slider is moved toward the rotation axis of the latch, and
as the slider is moved from the second slider position to the first slider position, the slider moves away from the rotation axis of the latch.

11. The cooking apparatus according to claim 1, wherein
the slider is configured to be linearly movable between the first slider position and the second slider position.

12. The cooking apparatus according to claim 11, further comprising
a slider guide fixed to the main body and configured to guide the slider so that the slider moves linearly between the first slider position and the second slider position.

13. The cooking apparatus according to claim 1, further comprising
a pusher position detection sensor configured to detect a position of the pusher.

14. The cooking apparatus according to claim 13, wherein
the pusher position detection sensor includes a switch configured to generate an electrical signal depending on whether or not the switch is pressed by the pusher,
with the pusher moved to the first pusher position, the pusher is spaced apart from the switch, and
as the pusher is moved from the first pusher position to the second pusher position, the switch is pressed by the pusher.

15. The cooking apparatus according to claim 1, further comprising
a connecting rod connecting the latch and the slider.
